(19) United States
(12) Patent Application Publication
(10) Pub. No.: US 2025/0291048 A1
(43) Pub. Date: Sep. 18, 2025

(54) DETERMINING TARGET RELATIVE CLOCK OFFSET FOR ULTRA-WIDEBAND (UWB) POSITIONING

(71) Applicant: QUALCOMM Incorporated, San Diego, CA (US)

(72) Inventors: Varun Amar REDDY, San Diego, CA (US); Aleksandar DAMNJANOVIC, Del Mar, CA (US); Krishna Kiran MUKKAVILLI, San Diego, CA (US)

(21) Appl. No.: 18/605,057

(22) Filed: Mar. 14, 2024

(51) Int. Cl. G01S 13/76; G01S 13/87

(52) U.S. Cl. CPC G01S 13/765; G01S 13/876

(57) ABSTRACT

Disclosed are techniques for wireless communication. In an aspect, an initiator device may transmit a ranging initiation message and a ranging final message to a plurality of responder devices. The initiator device may determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message. The initiator device may determine a time of flight based on one or more time of flight measurements and the target relative clock offset.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

Moreover, a fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements.

Also, there are other wireless communication systems developed for communications with an effective range shorter than that of the aforementioned wireless communication systems (e.g., LTE, WiMax, or 5G). The other wireless communication systems for short-range communications may be based on a radio access technology (RAT) such as WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc. In some aspects, these other wireless communication systems for short-range communications may be designed to provide data communications as well as positioning or ranging services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating an initiator device includes transmitting a ranging initiation message to a plurality of responder devices based on a first radio access technology (RAT); transmitting a ranging final message to the plurality of responder devices based on the first RAT; determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determining a time of flight between the initiator device and the target responder device based on one or more time of flight measurements and the target relative clock offset.

In an aspect, a method of operating a processing device includes obtaining a first reception time of a ranging initiation message that is from an initiator device and received by a target responder device of a first subset of a plurality of responder devices, or a second reception time of a ranging final message that is from the initiator device and received by the target responder device; obtaining a third reception time of a ranging response message that is from the target responder device and received by the initiator device; determining a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determining a time of flight between the initiator device and the target responder device based on the target relative clock offset associated with the target responder device, the third reception time, and one of the first reception time or the second reception time.

In an aspect, an initiator device includes one or more memories; one or more transceivers; and one or more processors communicatively coupled to the one or more memories and the one or more transceivers, the one or more processors, either alone or in combination, configured to: transmit, via the one or more transceivers, a ranging initiation message to a plurality of responder devices based on a first radio access technology (RAT); transmit, via the one or more transceivers, a ranging final message to the plurality of responder devices based on the first RAT; determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on one or more time of flight measurements and the target relative clock offset.

In an aspect, a processing device includes one or more memories; one or more transceivers; and one or more processors communicatively coupled to the one or more memories and the one or more transceivers, the one or more processors, either alone or in combination, configured to: obtain a first reception time of a ranging initiation message that is from an initiator device and received by a target responder device of a first subset of a plurality of responder devices, or a second reception time of a ranging final message that is from the initiator device and received by the target responder device; obtain a third reception time of a ranging response message that is from the target responder device and received by the initiator device; determine a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on the target relative clock offset associated with the target responder device, the third reception time, and one or both of the first reception time or the second reception time.

In an aspect, an initiator device includes means for transmitting a ranging initiation message to a plurality of responder devices based on a first radio access technology (RAT); means for transmitting a ranging final message to the plurality of responder devices based on the first RAT; means for determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and means for determining a time of flight between the initiator device and the target responder device based on one or more time of flight measurements and the target relative clock offset.

In an aspect, a processing device includes means for obtaining a first reception time of a ranging initiation message that is from an initiator device and received by a target responder device of a first subset of a plurality of responder devices, or a second reception time of a ranging final message that is from the initiator device and received by the target responder device; means for obtaining a third reception time of a ranging response message that is from the target responder device and received by the initiator device; means for determining a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and means for determining a time of flight between the initiator device and the target responder device based on the target relative clock offset associated with the target responder device, the third reception time, and one or both of the first reception time or the second reception time.

In an aspect, a non-transitory computer-readable medium stores computer-executable instructions that, when executed by an initiator device, cause the initiator device to: transmit a ranging initiation message to a plurality of responder devices based on a first radio access technology (RAT); transmit a ranging final message to the plurality of responder devices based on the first RAT; determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on one or more time of flight measurements and the target relative clock offset.

In an aspect, a non-transitory computer-readable medium stores computer-executable instructions that, when executed by a processing device, cause the processing device to: obtain a first reception time of a ranging initiation message that is from an initiator device and received by a target responder device of a first subset of a plurality of responder devices, or a second reception time of a ranging final message that is from the initiator device and received by the target responder device; obtain a third reception time of a ranging response message that is from the target responder device and received by the initiator device; determine a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on the target relative clock offset associated with the target responder device, the third reception time, and one or both of the first reception time or the second reception time.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example application of a positioning procedure based on a short-range wireless communication system, according to aspects of the disclosure.

FIG. 2 is a diagram showing the frequency bands of various radio access technologies (RATs), according to aspects of the disclosure.

FIG. 3A illustrates an example architecture of a wireless communication device, according to various aspects of the disclosure.

FIG. 3B illustrates an example architecture of a processing device, according to various aspects of the disclosure.

FIGS. 4A and 4B are diagrams illustrating example ranging operations, according to aspects of the disclosure.

FIG. 5 is a diagram illustrating a double-sided two-way ranging (DS-TWR) procedure, according to aspects of the disclosure.

FIG. 6 is a diagram illustrating a single-sided two-way ranging (SS-TWR) procedure, according to aspects of the disclosure.

FIG. 7 is a diagram illustrating an example ranging block structure, according to aspects of the disclosure.

FIG. 8 is a diagram illustrating an example ranging round for performing a positioning procedure, according to aspects of the disclosure.

FIG. 9 is a diagram illustrating a message flow for performing a positioning procedure, according to aspects of the disclosure.

FIG. 10 is a flowchart illustrating a method of operating an initiator device, according to aspects of the disclosure.

FIG. 11 is a flowchart illustrating a method of operating a processing device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to messaging schedule for ultra-wideband (UWB) positioning. Some aspects more specifically relate to determining a target relative clock offset of a target responder device that is not double-sided two-way ranging (DS-TWR) capable based on additional information from one or more reference responder devices that are DS-TWR capable.

Particular aspects of the subject matter described in this disclosure can be implemented to realize one or more of the following potential advantages. In some examples, an initiator device or a processing device may determine a target relative clock offset of a target responder device that is not DS-TWR capable with improved accuracy. Accordingly, the measurement results associated with the target responder device that is not DS-TWR capable may still be usable for determining a location of the initiator device with sufficient accuracy.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

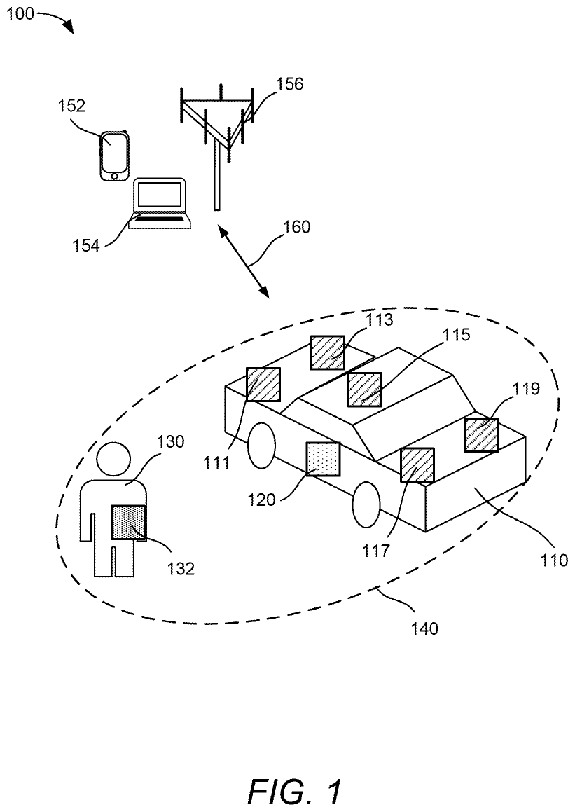

FIG. 1 illustrates an example application 100 of a positioning procedure based on a short-range wireless communication system, according to aspects of the disclosure. As shown in FIG. 1, as a non-limiting example, a vehicle 110 may include responder devices 111, 113, 115, 117, and 119 installed therein. The vehicle 110 may include a processing device 120 installed therein. In some aspects, the processing device 120 may be communicatively coupled to the responder devices 111, 113, 115, 117, and 119 and may be configured to control the operations of the responder devices 111, 113, 115, 117, and 119. In some aspects, the processing device 120 may be implemented as a computer onboard the vehicle 110 different from the responder devices 111, 113, 115, 117, and 119. In some aspects, the processing device 120 may be incorporated in one of the responder devices 111, 113, 115, 117, and 119. Moreover, in this a non-limiting example, a user 130 may carry an initiator device 132.

In some aspects, the initiator device 132 may be configured to communicate with the responder devices 111, 113, 115, 117, and 119 based on at least a first radio access technology (RAT) in order to perform a positioning procedure to determine a position of the initiator device 132 with respect to the responder devices 111, 113, 115, 117, and 119. In some aspects, the processing device 120 may determine if the position of the initiator device 132 is within a range 140 of the vehicle 110 in order to determine whether one or more functions of the vehicle 110 should be activated or deactivated (e.g., unlock the door, start the engine, start the air conditioning, etc.). In addition, the initiator device 132 may be configured to communicate with the responder devices 111, 113, 115, 117, and 119 based on the first RAT or a second RAT for data communication.

In some aspects, the first RAT may corresponds to an ultra-wideband radio access technology (e.g., ultra-wideband (UWB)) based on a first channel bandwidth. In some aspects, the second RAT may correspond to a short-range radio access technology (e.g., WiFi, Bluetooth®, or near-field communication (NFC)) based on a second channel bandwidth that is one-third or less of the first channel bandwidth.

In some aspects, the UWB devices may use pulse-based radio signaling (e.g. Short-pulse-UWB) instead of OFDM-based signaling (Multi-Band OFDM UWB). Short-pulse-UWB signaling transmits with the energy for each bit spread over the entire UWB channel bandwidth (e.g., 1.37 GHz, 4 GHz, etc.) with varying pulse amplitude and/or pulse polarity without using a RF carrier while MB-OFDM (Multi-Band-OFDM) transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g. Gaussian pulses, Monocycle pulses, Hermite pulses, etc) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

Multiband OFDM UWB divides up spectrum into several frequency sub-bands and OFDM is applied within each band; whereas, other OFDM systems typically operate within a fixed frequency band. The complex waveform created by combining the multiple-sub-bands results in a final waveform that used for transmission for Multiband OFDM UWB. Multiband OFDM UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

In some aspects, as shown in FIG. 1, other devices (e.g., a cell phone 152, a computer 154, and/or a base station 156) may communicate based on RATs such as 2G, 3G, LTE, 5G, WiFi, etc. In some aspects, the wireless communications performed by the other devices 152, 154, and/or 156 may interfere with the wireless communications between the initiator device 132 and the responder devices 111, 113, 115, 117, and 119 based on the first RAT (e.g., the interference being depicted as arrow 160 in FIG. 1).

In some aspects, a RAT according to 2G, 3G, LTE, 5G, and/or WiFi may arrange the available radio frequency (RF) resources into narrower RF bands. In some aspects, data transmitted using the RAT according to 2G, 3G, LTE, 5G, and/or WiFi may be modulated into an RF signal based on using an RF sinusoidal signal as a carrier at a designated frequency of each band. In some aspects, a receiver of the RAT according to 2G, 3G, LTE, 5G, and/or WiFi may distinguish the signals (intended for the receiver) from noises (including background noises and other signals not intended for the receiver) in the frequency domain based on a filter with a central frequency matching the frequency of the carrier.

In contrast, UWB (e.g., short-pulse-UWB) may use a pulse that has a short duration in the time domain with a low energy level for short-range, high-bandwidth communications over a large portion of the radio spectrum. UWB has traditionally been used for non-cooperative radar imaging, and more recently, for sensor data collection, precision locating, and tracking applications. In some aspects, data transmitted using UWB may be based on varying pulse amplitude and/or pulse polarity without using an RF carrier. In some aspects, a receiver according to UWB may distinguish the signals from noises in the time domain based on synchronization and/or a pulse template for the UWB communication.

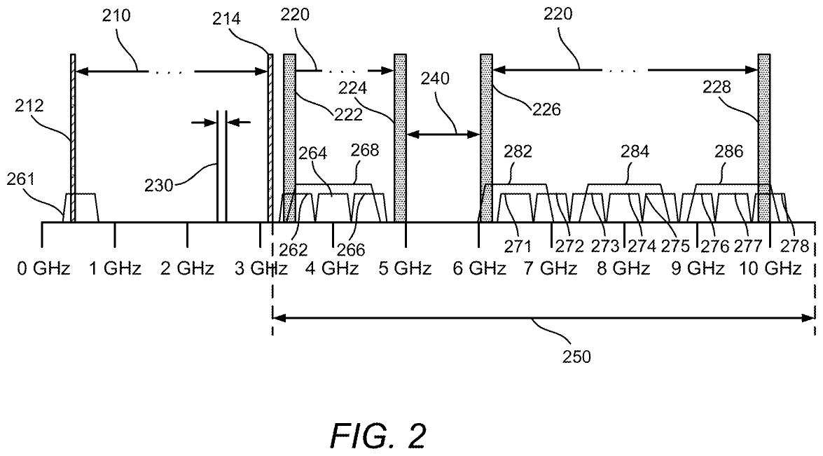

FIG. 2 is a diagram showing the frequency bands of various RATs, according to aspects of the disclosure. In FIG. 2, the frequency is represented horizontally and increasing from left to right. As shown in FIG. 2, the 2G, 3G, and/or 4G may use at least various frequency bands 210, including, e.g., frequency bands 212 and 214, with central frequencies ranging from about 400 MHz to 3.1 GHz. In some aspects, the 5G may use at least various frequency bands 220, including, e.g., frequency bands 222, 224, 226, and 228, with central frequencies ranging from about 3.2 GHz to 5.0 GHz and 6 GHz to 10 GHz. In some aspects, WiFi based on the Institute of Electrical and Electronics Engineers (IEEE) 802.11b/g specification may have channels 220 with central frequencies ranging from about 2.4 MHz to 2.5 MHz. In some aspects, WiFi based on the IEEE 802.11a/n specification may have channels 240 with central frequencies ranging from about 5 GHz to 6 GHz. In some aspects, these bands and channels illustrated in FIG. 2 are merely non-limiting examples depicted in a simplified manner.

As shown in FIG. 2, in some aspects, the United States Federal Communications Commission (FCC) has authorized the UWB applications within at least the frequency range 250 from 3.1 GHz to 10.6 GHz. In some aspects, the UWB may be configured to use a channel 261 (e.g., identified as Channel #0 in some UWB specifications) with a central frequency at about 500 MHz (e.g., 499.2 MHz) and a bandwidth of about 500 MHz (e.g., 499.2 MHz). In some aspects, channel 261 is also referred to as in a sub-GHz band.

In some aspects, the UWB may be configured to use channels 262, 264, and 266 (e.g., respectively identified as Channel #1, #2, and #3 in some UWB specifications) with central frequencies at about 3.5 GHz (e.g., 3.4944 GHz), 4.0 GHz (e.g., 3.9936 GHz), and 4.5 GHz (e.g., 4.4928 GHz), and a bandwidth of about 500 MHz (e.g., 499.2 MHz). In some aspects, the UWB may be configured to use a channel 268 (e.g., identified as Channel #4 in some UWB specifications) with a central frequency at about 4.0 GHz (e.g., 3.9936 GHz) and a bandwidth of about 1300 MHz (e.g., 1331.2 MHz). In some aspects, channels 262, 264, 266, and 268 are also referred to as in a low band.

In some aspects, the UWB may be configured to use channels 271, 272, 273, 274, 275, 276, 277, and 278 (e.g., respectively identified as Channel #5, #6, #8, #9, #10, #12, #13, and #14 in some UWB specifications) with central frequencies at about 6.5 GHz (e.g., 6.4869 GHz), 7.0 GHz (e.g., 6.9888 GHz), 7.5 GHz (e.g., 7.4880 GHz), 8.0 GHz (e.g., 7.9872 GHz), 8.5 GHz (e.g., 8.4864 GHz), 9.0 GHz (e.g., 9.9856 GHz), 9.5 GHz (e.g., 9.4848 GHz), and 10.0 GHz (e.g., 9.9840 GHz), and a bandwidth of about 500 MHz (e.g., 499.2 MHz). In some aspects, the UWB may be configured to use a channel 282 (e.g., identified as Channel #7 in some UWB specifications) with a central frequency at about 6.5 GHz (e.g., 6.4869 GHz) and a bandwidth of about 1100 MHz (e.g., 1081.6 MHz). In some aspects, the UWB may be configured to use a channel 284 (e.g., identified as Channel #11 in some UWB specifications) with a central frequency at about 8.0 GHz (e.g., 7.9872 GHz) and a bandwidth of about 1300 MHz (e.g., 1331.2 MHz). In some aspects, the UWB may be configured to use a channel 286 (e.g., identified as Channel #15 in some UWB specifications) with a central frequency at about 9.5 GHz (e.g., 9.4848 GHz) and a bandwidth of about 1300 MHz (e.g., 1354.97 MHz). In some aspects, channels 271, 272, 273, 274, 275, 276, 277, 278, 282, 284, and 286 are also referred to as in a high band.

As shown in FIG. 2, any of the RATs that is not UWB may have a channel bandwidth that is one-third or less of the channel bandwidth of the UWB. Also, as the UWB is configured to use channels that overlap with the channels of various non-UWB RATS, the transmissions based on the UWB may be subject to interference caused by the non-UWB RATs.

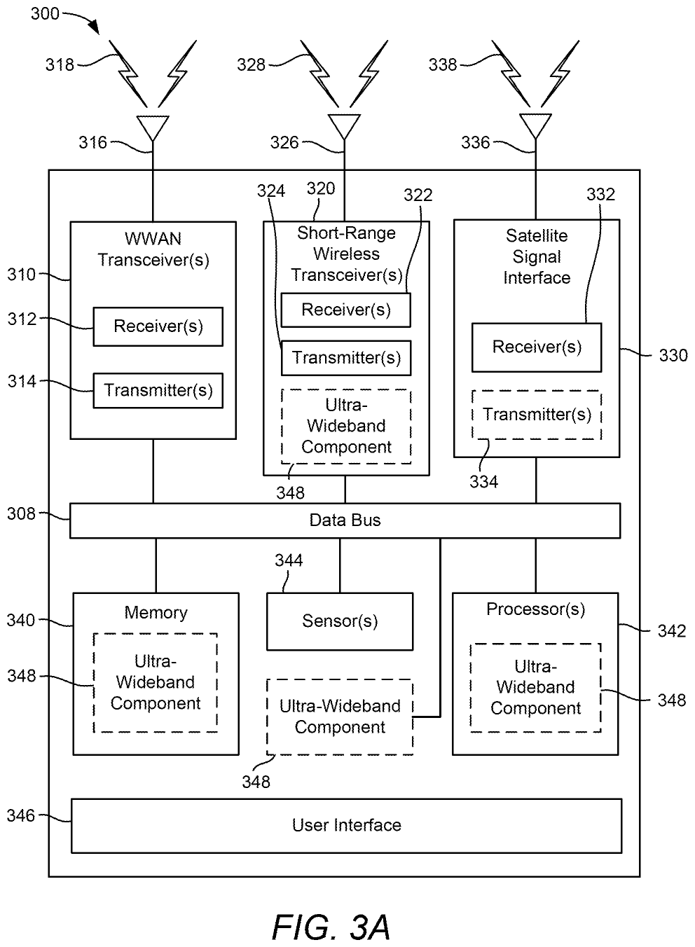

FIG. 3A illustrates an example architecture of a wireless communication device 300, according to various aspects of the disclosure. FIG. 3A illustrates several example components (represented by corresponding blocks) that may be incorporated into the wireless communication device 300 (which may correspond to any of the initiator device or the responder devices illustrated in FIG. 1, and/or the processing device in FIG. 1 if the processing device is included in one of the responder devices). Also, FIG. 3B illustrates an example architecture of a processing device 360, according to various aspects of the disclosure. In some aspects, the processing device 360 may correspond to the processing device in FIG. 1 if the processing device is coupled to the responder devices but arranged outside the responder devices.

It will be appreciated that various components depicted in FIGS. 3A and 3B may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

As shown in FIG. 3A, the wireless communication device 300 includes, at least in some cases, one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other wireless communication devices (e.g., user equipments (UE) s), access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The wireless communication device 300 also includes one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other wireless communication devices, access points, base stations, etc., via at least one designated RAT (e.g., Wi-Fi, LTE-D, BLUETOOTH®, ZIGBEE®, Z-WAVE®, PC5, DSRC, WAVE, NFC, UWB, etc.) over a wireless communication medium of interest. The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The wireless communication device 300 also includes, at least in some cases, a satellite signal interface 330, which includes one or more satellite signal receivers 332 and may optionally include one or more satellite signal transmitters 334. The one or more satellite signal receivers 332 may be connected to one or more antennas 336 and may provide means for receiving and/or measuring satellite positioning/communication signals 338. Where the one or more satellite signal receivers 332 include a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 332 include a non-terrestrial network (NTN) receiver, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine locations of the wireless communication device 300 using measurements obtained by any suitable satellite positioning system algorithm.

The optional satellite signal transmitter(s) 334, when present, may be connected to the one or more antennas 336 and may provide means for transmitting satellite positioning/communication signals 338. Where the one or more satellite signal transmitters 334 include an NTN transmitter, the satellite positioning/communication signals 338 may be communication signals (e.g., carrying control and/or user data) originating from a 5G network. The one or more satellite signal transmitters 334 may comprise any suitable hardware and/or software for transmitting satellite positioning/communication signals 338. The one or more satellite signal transmitters 334 may request information and operations as appropriate from the other systems.

As shown in FIG. 3B, the processing device 360 may include one or more network transceivers 390 providing means for communicating (e.g., means for transmitting, means for receiving, etc.) with the responder devices coupled thereto.

A transceiver (e.g., any of the transceivers in FIGS. 3A and 3B) may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., wireless communication device 300) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., wireless communication device 300) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, or the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., wireless communication device 300) and a base station will generally relate to signaling via a wireless transceiver.

The wireless communication device 300 and the processing device 360 also include other components that may be used in conjunction with the operations as disclosed herein. The wireless communication device 300 and the processing device 360 may include one or more processors 342 and 394 for providing functionality relating to, for example, wired or wireless communication, and for providing other processing functionality. The one or more processors 342 and 394 may therefore provide means for processing, such as means for determining, means for calculating, means for receiving, means for transmitting, means for indicating, etc. In an aspect, the one or more processors 342 and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The wireless communication device 300 and the processing device 360 may include memory circuitry implementing memory 340 and 396 (e.g., each including a memory device) for maintaining information (e.g., information indicative of reserved resources, thresholds, parameters, and so on). The memory 340 and 396 may therefore provide means for storing, means for retrieving, means for maintaining, etc. In some cases, the wireless communication device 300 and the processing device 360 may include an ultra-wideband component 348 or 398. The ultra-wideband component 348 or 398 may be hardware circuits that are part of or coupled to the one or more processors 342 or 394 that, when executed, cause the wireless communication device 300 or the processing device 360 to perform the functionality described herein. In other aspects, the ultra-wideband component 348 may be external to the processors 342 or 394 (e.g., part of a modem processing system, integrated with another processing system, etc.). Alternatively, the ultra-wideband component 348 or 398 may be a memory module stored in the memory 340 or the memory 396 that, when executed by the one or more processors 342 or 394 (or a modem processing system, another processing system, etc.), cause the wireless communication device 300 or the processing device 360 to perform the functionality described herein. FIGS. 3A and 3B illustrate possible locations of the ultra-wideband component 348 or 398, which may be, for example, part of the one or more short-range wireless transceivers 320, the one or more network transceivers 390, the memory 340, the memory 396, the one or more processors 342, the one or more processors 394, or any combination thereof, or may be a standalone component.

The wireless communication device 300 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems. Note that at least the accelerometer and gyroscope may be referred to as “inertial” sensors.

The various components of the wireless communication device 300 may be communicatively coupled to each other over a data bus 308. In an aspect, the data bus 308 may form, or be part of, a communication interface of the wireless communication device 300. Also the various components of the processing device 360 may be communicatively coupled to each other over a data bus 392. In an aspect, the data bus 392 may form, or be part of, a communication interface of the processing device 360.

In addition, the wireless communication device 300 includes a user interface 346 providing means for providing indications (e.g., audible and/or visual indications) to a user and/or for receiving user input (e.g., upon user actuation of a sensing device such a keypad, a touch screen, a microphone, and so on).

For convenience, the wireless communication device 300 and the processing device 360 are shown in FIGS. 3A and 3B as including various components that may be configured according to the various examples described herein. It will be appreciated, however, that the illustrated components may have different functionality in different designs. In particular, various components in FIGS. 3A and 3B may be optional in alternative configurations and the various aspects include configurations that may vary due to design choice, costs, use of the device, or other considerations. For example, a particular implementation of wireless communication device 300 may omit the WWAN transceiver(s) 310 (e.g., a wearable device or tablet computer or PC or laptop may have Wi-Fi and/or BLUEOOTH® capability without cellular capability), or may omit the satellite signal interface 330, or may omit the sensor(s) 344, and so on. For brevity, illustration of the various alternative configurations is not provided herein, but would be readily understandable to one skilled in the art.

The components of FIGS. 3A and 3B may be implemented in various ways. In some implementations, the components of FIGS. 3A and 3B may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 398 may be implemented by processor and memory component(s) of the wireless communication device 300 or the processing device 360 (e.g., by execution of appropriate code and/or by appropriate configuration of processor components). For simplicity, various operations, acts, and/or functions are described herein as being performed “by a wireless communication device,” “by an initiator device,” “by a responder device,” and/or “by a processing device.” However, as will be appreciated, such operations, acts, and/or functions may actually be performed by specific components or combinations of components of the wireless communication device 300 or the processing device 360, such as the one or more processors 342, the one or more transceivers 310 and 320, the memory 340, the ultra-wideband component 348, the one or more processors 394, the one or more transceivers 390, the memory 396, the ultra-wideband component 398, etc.

In some aspects, UWB uses time of flight (ToF) to determine the distance between two or more enhanced ranging devices (ERDEVs). ToF is the propagation time that it takes for a radio frequency (RF) signal to travel from the transmitter to the receiver. The distance between the transmitter and receiver can be calculated by multiplying the ToF by the speed of light. Where a target device performs ranging procedures with multiple anchor devices (devices with known locations), the location of the target device can be determined based on the calculated distances between the target device and the anchor devices and the known locations of the anchor devices. The location of the target device may be determined by a positioning entity, which may be the target device itself, one of the anchor devices, a processing device communicatively coupled to the target device and/or the anchor devices, or a location server.

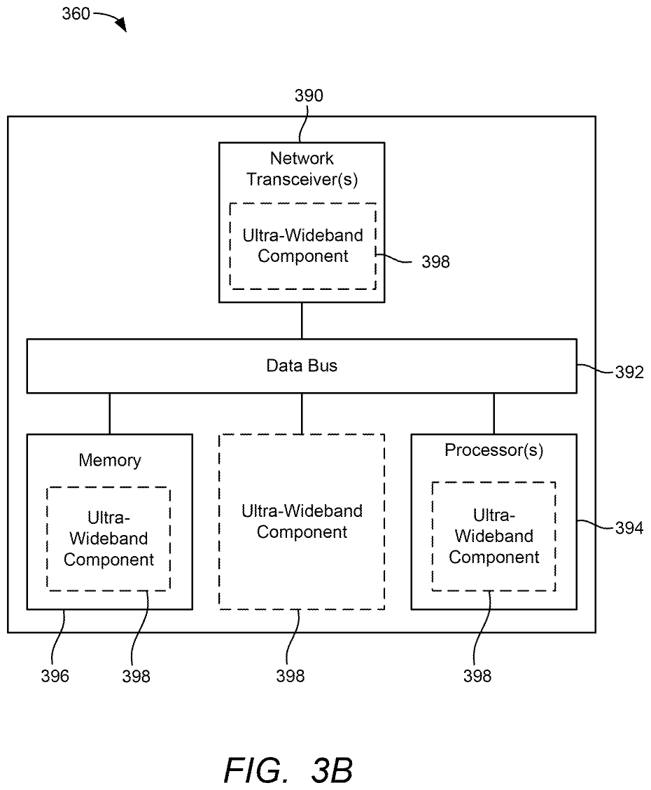

FIGS. 4A and 4B are diagrams 400A and 400B illustrating example ranging operations, according to aspects of the disclosure. The following nomenclature is used for ERDEVs. Controller: An ERDEV that controls the ranging and defines the ranging parameters by sending a ranging control message (RCM). Controlec: An ERDEV that utilizes the ranging parameters received from the controller in the RCM. Initiator (or an initiator device): An ERDEV that, following the RCM, initiates a ranging exchange by sending the first message of the exchange, the ranging initiation message (RIM). Responder (or a responder device): An ERDEV that responds to the ranging initiation message received from the initiator, with a ranging response message (RRM).

In some aspects, a controller can be configured as an initiator, and a controlee can be configured as a responder, as shown in FIG. 4A. In some aspects, a controller can be configured as a responder, and a controlee can be configured as an initiator, as shown in FIG. 4B. In some aspects, the initiator in FIG. 4A and FIG. 4B may correspond the initiator device described in FIG. 1, and the responder in FIG. 4A and FIG. 4B may correspond the responder device described in FIG. 1.

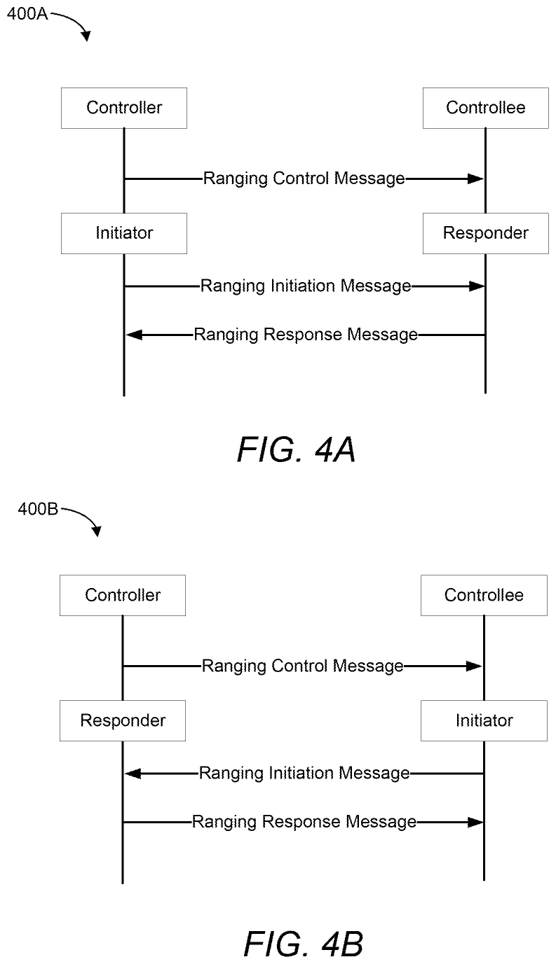

FIG. 5 is a diagram illustrating a double-sided two-way ranging (DS-TWR) procedure 500, according to aspects of the disclosure. The DS-TWR procedure 500 is performed between a first ERDEV acting as an initiator device (labeled “ERDEV I”) and a second ERDEV acting as a responder device (labeled “ERDEV R”). In a DS-TWR procedure 500, multiple exchanges are made between the two ERDEVs to mitigate the effect of clock skew.

In some aspects, the first ERDEV may transmit a message (e.g., a ranging initiation message, RIM) 510, which may include a ranging marker 512. The first ERDEV may timestamp the ranging marker 512 at the time of transmission thereof. The second ERDEV may receive the message 510 and timestamp the ranging marker 512 at the time of reception thereof. The ToF between the two ERDEVs (labeled “T_prop”) may correspond to the time difference between the (transmission) timestamp of the ranging marker 512 at first ERDEV and the (reception) timestamp of the ranging marker 512 at second ERDEV.

In some aspects, the second ERDEV may transmit a message (e.g., a ranging response message, RRM) 520, which may include a ranging marker 522. The second ERDEV may timestamp the ranging marker 522 at the time of transmission thereof. The first ERDEV may receive the message 520 and timestamp the ranging marker 522 at the time of reception thereof. The ToF between the two ERDEVs (labeled “T_prop”) may correspond to the time difference between the (transmission) timestamp of the ranging marker 522 at second ERDEV and the (reception) timestamp of the ranging marker 522 at first ERDEV. The first ERDEV may also obtain a round-trip time (labeled “T_rnd_I”) between the ranging marker 512 and the ranging marker 522 at the first ERDEV. In addition, the message 520 may include the information corresponding to the time between the ranging marker 512 and the ranging marker 522 at the second ERDEV (labeled “T_rep_R”).

In some aspects, the first ERDEV may further transmit a message (e.g., a ranging final message, RFM) 530, which may include a ranging marker 532. The first ERDEV may timestamp the ranging marker 532 at the time of transmission thereof. The second ERDEV may receive the message 530 and timestamp the ranging marker 532 at the time of reception thereof. The ToF between the two ERDEVs (labeled “T_prop”) may correspond to the time difference between the (transmission) timestamp of the ranging marker 532 at first ERDEV and the (reception) timestamp of the ranging marker 532 at second ERDEV. The second ERDEV may also obtain a round-trip time (labeled “T_md_R”) between the ranging marker 522 and the ranging marker 532 at the second ERDEV. In addition, the message 530 may include the information corresponding to the time between the ranging marker 522 and the ranging marker 532 at the first ERDEV (labeled “T_rep_I”).

In some aspects, the three message 510, 520, and 530 help correct the clock offset error between the transmitter and receiver (since the ERDEVs clocks may not be synchronized). In some aspects, the ToF between the two ERDEVs (T_prop) may be calculated as T_prop=(T_rnd_I×T_rnd_R−T_rep_R×T_rep_I)/(T_rnd_I+T_rnd_R+T_rep_R+T_rep_I). Note that either or both of the illustrated ERDEVs may perform additional ranging procedures with other ERDEVs.

In some aspects, considering the clock drift of the ERDEVs, the calculated ToF (T_prop) and the true ToF (T_prop′) may be determined based on the expression of T_prop=T_prop′+ (e_I−e_R)×(T_rep_R−T_rep_I)/4, where e_I represents the clock drift of the first ERDEV, and e_R represents the clock drift of the second ERDEV. In some aspects, when the DS-TWR procedure 500 is configured to be symmetrical, the term (T_rep_R−T_rep_I) may be deemed zero and T_prop′ and T_prop may be deemed as the same.

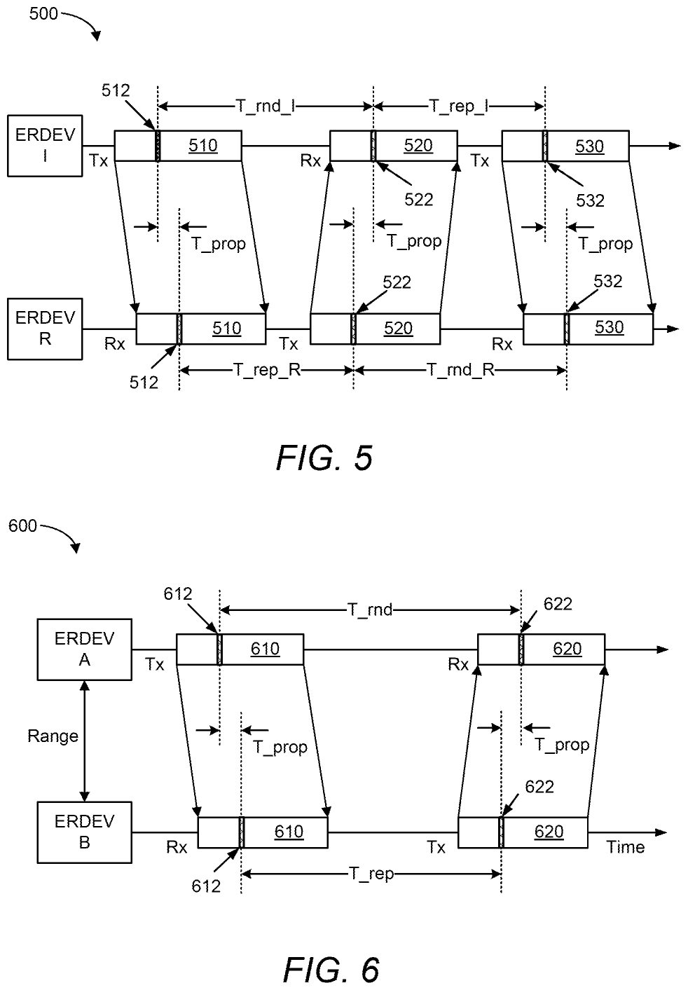

FIG. 6 is a diagram illustrating a single-sided two-way ranging (SS-TWR) procedure 600, according to aspects of the disclosure. The SS-TWR procedure 600 is performed between a first ERDEV (labeled “ERDEV A”) and a second ERDEV (labeled “ERDEV B”).

In some aspects, the first ERDEV may transmit a message 610, which may include a ranging marker 612. The first ERDEV may timestamp the ranging marker 612 at the time of transmission thereof. The second ERDEV may receive the message 610 and timestamp the ranging marker 612 at the time of reception thereof. The ToF between the two ERDEVs (labeled “T_prop”) may correspond to the time difference between the (transmission) timestamp of the ranging marker 612 at first ERDEV and the (reception) timestamp of the ranging marker 612 at second ERDEV.

In some aspects, the second ERDEV may transmit a message 620, which may include a ranging marker 622. The second ERDEV may timestamp the ranging marker 622 at the time of transmission thereof. The first ERDEV may receive the message 620 and timestamp the ranging marker 622 at the time of reception thereof. The ToF between the two ERDEVs (labeled “T_prop”) may correspond to the time difference between the (transmission) timestamp of the ranging marker 622 at second ERDEV and the (reception) timestamp of the ranging marker 622 at first ERDEV. The first ERDEV may also obtain a round-trip time (labeled “T_rnd”) between the ranging marker 612 and the ranging marker 622 at the first ERDEV. In addition, the message 620 may include the information corresponding to the time between the ranging marker 612 and the ranging marker 622 at the second ERDEV (labeled “T_rep”).

In some aspects, the ToF between the two ERDEVs (T_prop) may be calculated as T_prop=½(T_rnd−T_rep). Note that either or both of the illustrated ERDEVs may perform additional ranging procedures with other ERDEVs.

In some aspects, the SS-TWR procedure 600 may be configured as a part of, or as a backup of, the DS-TWR procedure 500. In some aspects, while the first ERDEV is configured as an initiator device and the second ERDEV is configured as a responder device, the message 610 may be an RIM, and the message 620 may be a RRM. In some aspects, while the first ERDEV is configured as a responder device and the second ERDEV is configured as an initiator device, the message 610 may be an RRM, and the message 620 may be a RFM.

In some aspects, considering the clock drift of the ERDEVs, the calculated ToF (T_prop) and the true ToF (T_prop′) may be determined based on the expression of T_prop=T_prop′+(e_A−e_B)×T_rep/2, where e_A represents the clock drift of the first ERDEV, and e_B represents the clock drift of the second ERDEV.

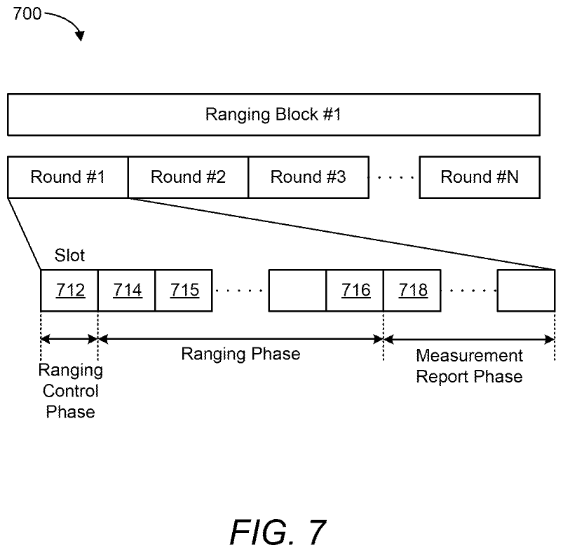

In some aspects, for time-scheduled or contention-free ranging in UWB, a positioning procedure based on UWB may be performed using consecutive ranging blocks. FIG. 7 is a diagram 700 illustrating an example ranging block structure, according to aspects of the disclosure. In some aspects, each block may have a duration of 200 ms. As shown in FIG. 7, each ranging block consists of ranging rounds, which in turn have several ranging slots. In some aspects, the number of rounds within a block and/or the number of slots within a round may be configured by the UWB controller.

In some aspects, within a ranging block, a single ranging round may be selected for the positioning procedure. In some aspects, the selected round index may be statically configured by the controller or selected as per a hopping pattern. In some aspects, the slot duration may range from 1 ms to 2.66 ms. In some aspects, the actual ranging message may only take a portion of the slot (e.g., a packet of about 150 us), and the remainder of the slot may be retained for processing delays.

In some aspects, each round consists of a single slot for a control phase, followed by one or more slots for a ranging phase and one or more slots for a measurement reporting phase. In some aspects, during a first slot 712 of the selected round (e.g., Round #1), a controller may transmit an RCM to an initiator device and one or more responder devices for a positioning procedure based on an ultra-wideband RAT (e.g., UWB) and/or a non-ultra-wideband RAT (e.g., WiFi or Bluetooth®). In some aspects, the controller may be the initiator device or one of the one or more responder devices, and the controller may not need to transmit the RCM to itself.

In some aspects, during the ranging phase (e.g., during a first slot 714 of the ranging phase), the initiator device may transmit an RIM to the one or more responder devices. Afterwards, the one or more responder devices may transmit corresponding one or more RRMs in respective slots (e.g., slot 715) as scheduled based on the RCM. The initiator device may then transmit an RFM to the one or more responder devices at a slot (e.g., slot 716) as scheduled based on the RCM after the slots for the RRMs. Finally, in some aspects, the initiator device and the one or more responder devices may transmit and/or receive one or more measurement report messages (MRMs) during the measurement report phase using the slot(s) (e.g., slot 718) as scheduled based on the RCM.

In some aspects, a frame for communications based on a non-ultra-wideband RAT may have a duration (e.g., 10 ms) comparable to a duration of a ranging round. In some aspects, a subframe for communications based on a non-ultra-wideband RAT may have a duration (e.g., 1 ms) comparable to a duration of a ranging slot. In some aspects, a collision of the signals from a communication system based on a non-ultra-wideband RAT and a message in a ranging slot based on an ultra-wideband RAT may likely reappear in subsequent ranging rounds or blocks.

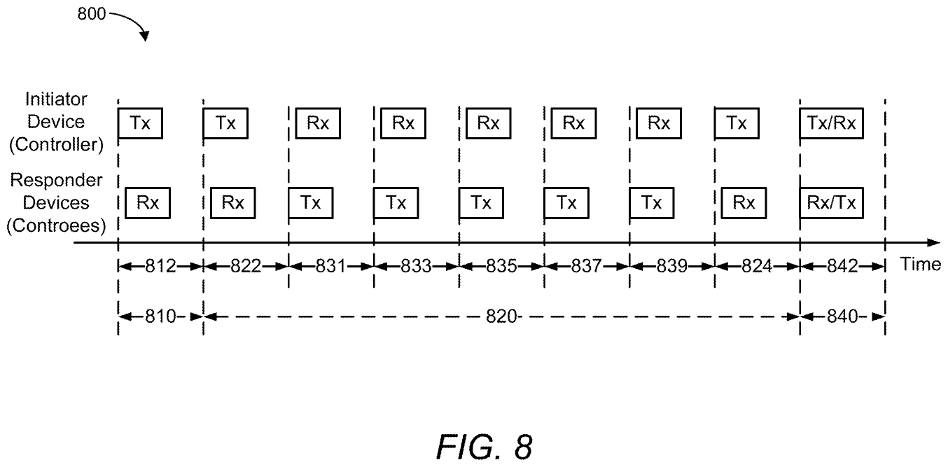

FIG. 8 is a diagram 800 illustrating an example ranging round for performing a positioning procedure (e.g., a DS-TWR procedure), according to aspects of the disclosure. In FIG. 8, time is represented horizontally. The “Tx” labeled in a box represents that a message may be transmitted, and “Rx” labeled in a box represents that a message transmitted within the same slot may be received. As shown in the diagram 800, a ranging round may include a control phase 810, a ranging phase 820, and a measurement reporting phase 840. In this non-limiting example, the control phase 810 may include a slot 812; the ranging phase 820 may include slots 822, 831, 833, 835, 837, 839, and 824; and the measurement reporting phase 840 may include a slot 842.

In this example, a positioning procedure may be performed to determine a location of an initiator device with respect to five (5) responder devices. For illustration purposes, the initiator device is configured as a controller of the positioning procedure, and the responder devices are configured as the controlees of the positioning procedure. In some aspects, this configuration may corresponding to a user device (e.g., a UE) being configured as the initiator device and the five responder devices being installed onboard a vehicle for determining if the user device is in close proximity to the vehicle.

In this example, the initiator device (as the controller) may transmit an RCM to the responder devices at slot 812. In some aspects, the RCM may include the schedule of the slots for the round, including at least how the slots of the ranging phase 820 and the measurement reporting phase 840 are arranged. The initiator device may transmit an RIM to the responder devices at slot 822 as scheduled based on the RCM. In some aspects, each of the responder devices may be assigned to transmit an RRM during a respective slot. Accordingly, the responder devices may transmit, and the initiator device may receive, respective RRMs at slot 831, 833, 835, 837, and 839. Afterwards, the initiator device may transmit an RFM at slot 824. At the end of the ranging round, the initiator device may transmit its measurement results to the responder devices at slot 842. In some aspects, the responder devices may transmit their measurement results to the initiator device at slot 842 or one or more other slots in the measurement reporting phase 840.

In some aspects, due to interference from other communication system(s), one or more of the messages (e.g., RIM, RRMs, and/or RFM) may not be successfully received by the receiving entity (or being referred to as the message is “dropped”). In some aspects, for a given responder device, if any of the RIM, RRM, or RFM for the DS-TWR procedure is dropped, the affected responder may not have sufficient information to participate in the DS-TWR positioning procedure.

In some aspects, considering presence of interference, the responder devices used in a DS-TWR procedure may include a subset of responder devices that are affected by the interference (e.g., at least one of RIM, RRM, and/or RFM required for a DS-TWR procedure in association with a corresponding responder device being dropped) and another subset of responder devices corresponding to the remaining responder devices that are not affected by the interference. In some aspects, if either RIM or RFM is not received by a responder device, the ToF between the initiator device and such responder device may not be estimated based on the DS-TWR procedure, but may still be estimated based on a SS-TWR procedure, albeit with degraded accuracy. In some aspects, if RRM from a responder device is not received by the initiator device, the ToF between the initiator device and such responder device may at best based on a one-way ranging procedure that is less accurate than a two-way ranging procedure.

In some aspects, in operation, the initiator device may transmit, based on a first messaging schedule for a current ranging round, an RIM to a plurality of responder devices based on a first RAT (e.g., at slot 822). The initiator device may receive, based on the first messaging schedule, one or more RRMs from a subset of the responder devices based on the first RAT, the one or more RRMs may acknowledge reception of the RIM. The one or more RRMs may be received during the respective slots assigned to the respective responder devices according to the first messaging schedule (e.g., slots 831, 833, 835, 837, and 839). In some aspects, failure of receiving an RRM may be caused by the interference (i.e., the RRM is dropped). In some aspects, the initiator device may receive an RRM indicating that the corresponding responder device failed to receive the RIM (i.e., the RIM is dropped).

In some aspects, the initiator device may transmit, based on the first messaging schedule, an RFM to the plurality of responder devices based on the first RAT (e.g., at slot 824). In some aspects, the initiator device may further transmit, based on the first messaging schedule, a first measurement report message to the plurality of responder devices based on a second RAT (e.g., at slot 842). In some aspects, the initiator device may receive, based on the first messaging schedule, second measurement report messages from the plurality of responder devices based on the second RAT (e.g., at slot 842). In some aspects, the first RAT may correspond to an ultra-wideband RAT (e.g., UWB) based on a first channel bandwidth, and the second RAT may correspond to a short-range RAT (e.g., WiFi, Bluetooth®, or NFC) based on a second channel bandwidth that is one-third or less of the first channel bandwidth.

In some aspects, after the messages exchange within a ranging phase of a ranging round (e.g., the ranging phase 820 depicted in FIG. 8), the plurality of responders engaging in the ranging phase may be categorized into at least a first subset R₁ of the plurality of responder devices that are not available for a DS-TWR procedure as a result of the interference but still available for a SS-TWR procedure (e.g., provided the RRM successfully received by the initiator device, and one of RIM or RFM in association with the corresponding responder device being dropped) and a second subset R₂ of the plurality of responder devices that are available for the DS-TWR procedure (e.g., all RIM, RRM, and RFM required for a DS-TWR procedure in association with the corresponding responder device being received successfully). In some aspects, with additional information obtained based on the second subset R₂ of the plurality of responder devices, the first subset R₁ of the plurality of responder devices may still engage in the SS-TWR procedure with improved accuracy.

In some aspects, the initiator device may determine a target relative clock offset between a target responder device of the first subset R₁ of the plurality of responder devices and the initiator device based on one or more reference responder devices of the second subset R₂ of the plurality of responder devices. In some aspects, the initiator device may determine a ToF between the initiator device and the target responder device based on the target relative clock offset.

For example, as illustrated in FIG. 6, a true ToF (T_prop′) between the initiator device and the target responder device may be determined based on a measured ToF (T_prop) according to an equation of T_prop=T_prop′+(e_I−e_Ra)×T_rep/2, where e_I represents the clock drift of the initiator device (e.g., an initiator clock offset), and e_Ra represents the clock drift of the target responder device (e.g., a clock offset associated with the target responder device). In some aspects, the clock drift of the initiator device (e_I, the initiator clock offset) may be known to the initiator device, but the clock drift of the target responder device (e_Ra, the clock offset associated with the target responder device) determined based on the SS-TWR procedure may not be as accurate as those determined based on the DS-TWR procedure. In some aspects, provided that the clock drift of the a reference responder device (e_Rb, a reference clock offset associated with the reference responder device) of the second subset R₂ can be determined, an estimated clock offset (e.g., denoted e_Ra′) associated with the target responder device may be used in place of the clock drift of the target responder device (e_Ra). In some aspects, (e_I−e_Ra′) may be used in place of (e_I−e_Ra) as the target relative clock offset. In some aspects, as illustrated with reference to FIG. 6, the measured ToF (T_prop) may be determined based on (i) a first reception time of the RIM received by the target responder device, or a second reception time of the RFM received by the target responder device, and (ii) a third reception time of the corresponding ranging response messages from the target responder device received by the initiator device.

In some aspects, the initiator device may obtain the estimated clock offset (e_Ra′) based on receiving a measurement report message from one of the one or more reference responder devices based on a second RAT. In some aspects, the measurement report message may indicate an inter-responder clock offset (e.g., denoted e_ab) between the target responder device and the one of the one or more reference responder devices. The initiator device may determine a reference clock offset (e.g., denoted e_Rb) associated with the one of the one or more reference responder devices. In some aspects, the initiator device may determine the estimated clock offset (e_Ra′) based on the inter-responder clock offset (e_ab) and the reference clock offset (e_Rb). In some aspects, the estimated clock offset (e_Ra′) may be determined based on an equation of e_Ra′=e_ab−e_Rb.

In some aspects, the inter-responder clock offset (e_ab) may be determined based on a RRM from the target responder device to the initiator device but also heard by the one of the one or more reference responder devices. In some aspects, the inter-responder clock offset (e_ab) may be determined by the one of the one or more reference responder devices or a processing device coupled to the one of the one or more reference responder devices.

In some aspects, each of the plurality of responder devices and/or the processing device may determine, on a periodic basis or an on-demand basis, the inter-responder clock offsets among various pairs of the plurality of responder devices based on RRMs from the plurality of responder devices. In some aspects, the inter-responder clock offsets may be determined during a calibration stage for calibrating the timing and synchronization among the plurality of responder devices, during which the responder devices may by scheduled to be awake to listen to the RRMs from other responder devices. In some aspects, as the distances among the responder devices may be known to the responder devices and/or the processing device based on the designed locations for disposing the responder devices, the inter-responder clock offsets among the responder devices may be determined based on listening to the RRMs from the responder devices.

In some aspects, the initiator device may determine a set of relative clock offsets between the initiator device and the second subset R₂ of the plurality of responder devices that are capable of the DS-TWR procedure. In some aspects, as the responder devices (including the first subset R₁ and the second subset R₂) may be of the same make, same model, and similar factory batch in some applications, a statistic result of the relative clock offsets of the second subset R₂ of the plurality of responder devices may still provide a good estimation for the first subset R₁ of the plurality of responder devices. In some aspects, the initiator device may determine a set of estimated relative clock offsets between the initiator device and the first subset R₁ of the plurality of responder devices based on the set of relative clock offsets between the initiator device and the second subset R₂ of the plurality of responder devices.

For example, as illustrated in FIG. 5, the ToF between the initiator device and a reference responder device of the second subset R₂ (T_prop) may be calculated, based on the DS-TWR procedure as, T_prop=(T_rnd_I×T_rnd_R−T_rep_R×T_rep_I)/(T_rnd_I+T_rnd_R+T_rep_R+T_rep_I). Based on the calculated T_prop associated with the reference responder device, the relative clock offset between the reference responder device and the initiator device (e_I−e_R) may thus be determined. With all the relative clock offsets between the second subset R₂ of the plurality of responder devices determined, the initiator device may determine an average clock offset of the set of relative clock offsets (of the second subset R₂ of the plurality of responder devices). In some aspects, the initiator device may determine the target relative clock offset (e.g., (e_I−e_Ra′)) based on the average clock offset. In some aspects, the average clock offset may be used as the target relative clock offset for any responder device in the first subset R₁ of the plurality of responder devices.

In some aspects, the initiator device may receive indicators from the plurality of responder devices indicating whether the responder devices are capable of providing the inter-responder clock offsets. In some aspects according to a first scenario, the initiator device may receive an indication from the one of the one or more reference responder devices based on the second RAT prior to the RIM being transmitted, and the indication may indicate that the one of the one or more reference responder devices is capable of providing the inter-responder clock offset. According to the first scenario, the initiator device may obtain the estimated clock offset associated with the target responder device based on the inter-responder clock offset between the target responder device and the one of the one or more reference responder devices and then determine the target relative clock offset accordingly. In some aspects according to a second scenario, the initiator device may receive a plurality of indications from the plurality of responder devices based on the second RAT prior to the ranging initiation message being transmitted, and the plurality of indications may indicate that none of the plurality of responder devices are capable of providing an inter-responder clock offset between the target responder device and any one of the one or more reference responder device. According to the second scenario, the initiator device may determine the target relative clock offset based on the average clock offset of the second subset R₂ of the plurality of responder devices.

In some aspects, the first RAT may correspond to an ultra-wideband radio access technology (e.g., UWB) based on a first channel bandwidth. In some aspects, the second RAT corresponds to a short-range radio access technology (e.g., WiFi or Bluetooth®) based on a second channel bandwidth that is one-third or less of the first channel bandwidth.

In some aspects, the processing device coupled to the responder devices may be configured to determine the ToF between the initiator device and the target responder device. In some aspects, the processing device coupled to the responder devices may be outside of the responder devices or embedded in one of the responder devices.

In some aspects, the processing device may obtain either a first reception time of a RIM that is from the initiator device and received by the target responder device of the first subset R₁ of a plurality of responder devices, or a second reception time of a RFM that is from the initiator device and received by the target responder device. The processing device may obtain an estimated clock offset associated with the target responder device based on one or more reference responder devices of the second subset R₂ of the plurality of responder devices and then determine the target relative clock offset accordingly. The processing device may determine the ToF between the initiator device and the target responder device based on the target relative clock offset, the third reception time, and one of the first reception time or the second reception time.

In some aspects, the processing device may receive a first measurement report message from one of the one or more reference responder devices, where the measurement report message may indicate an inter-responder clock offset between the target responder device and the one of the one or more reference responder devices. In some aspects, the processing device may receive a second measurement report message from the initiator device, where the second measurement report may indicate a reference clock offset associated with the one of the one or more reference responder devices. In some aspects, the processing device may determine the estimated clock offset based on the inter-responder clock offset and the reference clock offset in a manner similar to how the initiator device may determine the estimated clock offset as illustrated above.

In some aspects, the inter-responder clock offset may be determined based on a RRM from the target responder device, and may be determined by the one of the one or more reference responder devices or the processing device. In some aspects, the processing device may determine, on a periodic basis or an on-demand basis, inter-responder clock offsets among various pairs of the plurality of responder devices based on ranging response messages from the plurality of responder devices.

In some aspects, the processing device may receive a third measurement report message from the initiator device, where the third measurement report may indicate a set of relative clock offsets between the initiator device and the second subset of the plurality of responder devices. In some aspects, the processing device may determine an average clock offset of the set of relative clock offsets, and may determine the target relative clock offset based on the average clock offset, in a manner similar to how the initiator device may determine the target relative clock offset as illustrated above.

In some aspects, the processing device may receive indicators from the plurality of responder devices indicating whether the responder devices are capable of providing the inter-responder clock offsets. In some aspects according to a first scenario, the processing device may receive an indication from the one of the one or more reference responder devices based on the second RAT prior to the RIM being transmitted, and the indication may indicate that the one of the one or more reference responder devices is capable of providing the inter-responder clock offset. According to the first scenario, the processing device may obtain the estimated clock offset associated with the target responder device based on the inter-responder clock offset between the target responder device and the one of the one or more reference responder devices. In some aspects according to a second scenario, the processing device may receive a plurality of indications from the plurality of responder devices based on the second RAT prior to the ranging initiation message being transmitted, and the plurality of indications may indicate that none of the plurality of responder devices are capable of providing an inter-responder clock offset between the target responder device and any one of the one or more reference responder device. According to the second scenario, the processing device may determine the target relative clock offset associated with the target responder device based on the average clock offset of the second subset R₂ of the plurality of responder devices.

In some aspects, the first RAT may correspond to an ultra-wideband radio access technology (e.g., UWB) based on a first channel bandwidth. In some aspects, the second RAT corresponds to a short-range radio access technology (e.g., WiFi or Bluetooth®) based on a second channel bandwidth that is one-third or less of the first channel bandwidth.

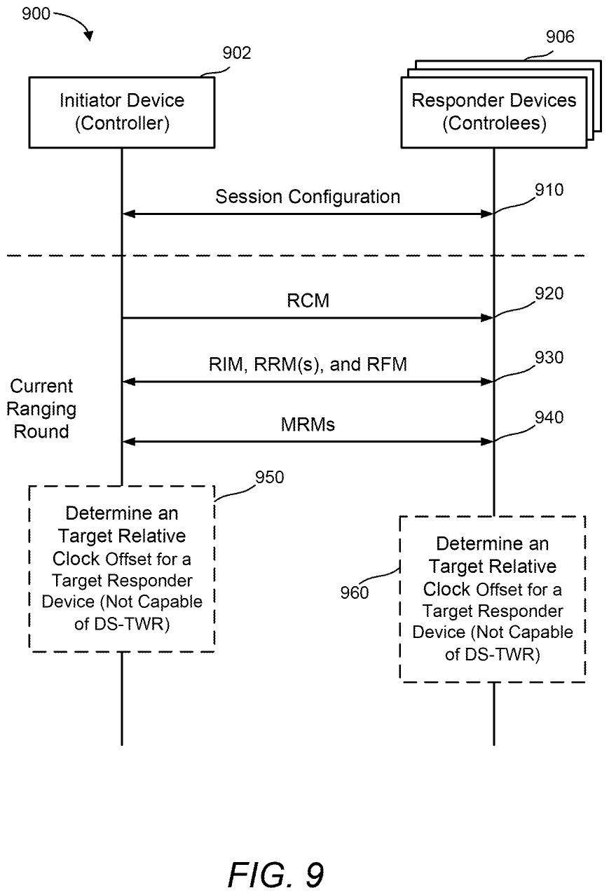

FIG. 9 is a diagram illustrating a message flow for performing a positioning procedure 900, according to aspects of the disclosure. As shown in FIG. 9, the initiator device 902 may be configured as a controller, and the responder devices 906 may be configured as controlees. In some aspects, the operations depicted as performed by the responder devices 906 may indeed correspond to operations performed by the responder devices, by a processing device embedded in one of the responder devices, and/or by a processing device coupled to but outside the responder devices.

In this procedure 900, prior to a current ranging round, the initiator device 902 (as the controller) and the responder devices 906 (as the controlees) may exchange capability information at a session configuration stage 910 indicating whether each one of the responder devices 906 is capable of indicating one or more inter-responder clock offsets between the corresponding responder device and one or more other responder devices.

During the current ranging round, the initiator device 902 may transmit an RCM to the responder devices 906 at stage 920, which may correspond to slot 812 in FIG. 8. In some aspects, the RCM may indicate a messaging schedule indicating how the slots during the ranging phase are assigned to the initiator device 902 and the responder devices 906. Next, the initiator device 902 may transmit an RIM, the responder devices 906 may transmit respective RRMs, and then the initiator device 902 may transmit an RFM as illustrated in FIG. 8 during the ranging phase 820 at stage 930. Afterwards, the initiator device 902 and the responder devices 906 may exchange MRMs as illustrated in FIG. 8 during the measurement reporting phase 840 at stage 940.

In some aspects, at stage 950, the initiator device 902 may determine a target relative clock offset for a target responder device that is not capable of the DS-TWR procedure. In some aspects, if the target responder device is capable of sending an inter-responder clock offset between the target responder device and a reference responder device as indicated at stage 910, the initiator device 902 may determine an estimated clock offset associated with the target responder device based on the inter-responder clock offset between the target responder device and the reference responder device and a reference clock offset associated with the reference responder device, and then determine the target relative clock offset accordingly, as discussed with reference to FIG. 8. In some aspects, if the target responder device is not capable of sending the inter-responder clock offset as indicated at stage 910, the initiator device 902 may determine the target relative clock offset associated with the target responder device based on an average relative clock offset of a subset of responder devices that are capable of the DS-TWR procedure as discussed with reference to FIG. 8.

In some aspects, at stage 960 as an additional stage or an alternative stage to stage 950, a processing device embedded in one of the responder devices 906 and/or a processing device coupled to the responder devices 906 but outside the responder devices 906 may determine the target relative clock offset for the target responder device. In some aspects, the processing device may determine, on a periodic basis or an on-demand basis, inter-responder clock offsets among various pairs of the responder devices 906 based on ranging response messages from the responder devices 906 as discussed with reference to FIG. 8. In some aspects, the processing device may determine the estimated clock offset for the target responder device based on an inter-responder clock offset between the target responder device and a reference responder device and a reference clock offset associated with the reference responder device, and then determine the target relative clock offset accordingly, as discussed with reference to FIG. 8. In some aspects, the processing device may obtain the needed timestamp information from the initiator device 902 and/or the responder devices 906 at stage 940. In some aspects, the processing device may determine the target relative clock offset for the target responder device based on an average relative clock offset of a subset of responder devices that are capable of the DS-TWR procedure as discussed with reference to FIG. 8.

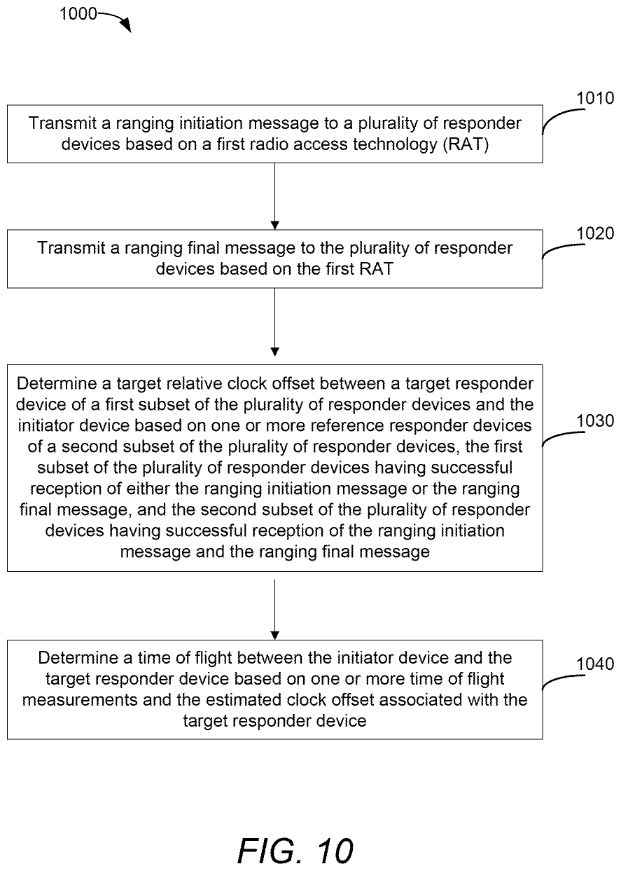

FIG. 10 is a flowchart illustrating a method 1000 of operating an initiator device, according to aspects of the disclosure. In some aspects, the initiator device in the method 1000 may correspond to the initiator device described in FIGS. 8 and 9. In some aspects, the initiator device may be a wireless communication device 300 described in FIG. 3A; and the method 1000 may be performed by the one or more WWAN transceivers 310, the one or more short-range wireless transceivers 320, the one or more processors 342, the memory 340, and/or the ultra-wideband component 348, any or all of which may be considered means for performing one or more of the following operations of method 1000.

At operation 1010, the initiator device may transmit a ranging initiation message (e.g., an RIM at slot 822 in FIG. 8 and/or an RIM at stage 930 in FIG. 9) to a plurality of responder devices based on a first RAT. In some aspects, operation 1010 may be performed by the one or more WWAN transceivers 310, the one or more short-range wireless transceivers 320, the one or more processors 342, the memory 340, and/or the ultra-wideband component 348, any or all of which may be considered means for performing operation 1010.

At operation 1020, the initiator device may transmit a ranging final message (e.g., an RFM at slot 824 in FIG. 8 and/or an RFM at stage 930 in FIG. 9) to the plurality of responder devices based on the first RAT. In some aspects, the initiator device may receive a plurality of ranging response messages (e.g., a subset of the RRMs at slots 831-839 in FIG. 8 and/or a subset of the RRMs at stage 930 in FIG. 9 that are successfully received by the initiator device) from the plurality of responder devices based on the first RAT. In some aspects, operation 1020 may be performed by the one or more WWAN transceivers 310, the one or more short-range wireless transceivers 320, the one or more processors 342, the memory 340, and/or the ultra-wideband component 348, any or all of which may be considered means for performing operation 1020.

At operation 1030, the initiator device may determine a target relative clock offset between a target responder device of a first subset of the plurality of responder devices and the initiator device based on one or more reference responder devices of a second subset of the plurality of responder devices. In some aspects, the first subset of the plurality of responder devices may have successful reception of either the ranging initiation message or the ranging final message. In some aspects, the second subset of the plurality of responder devices may have successful reception of the ranging initiation message and the ranging final message. In some aspects, operation 1030 may be performed by the one or more WWAN transceivers 310, the one or more short-range wireless transceivers 320, the one or more processors 342, the memory 340, and/or the ultra-wideband component 348, any or all of which may be considered means for performing operation 1030.

In some aspects, the initiator device may determine the target relative clock offset based on receiving a measurement report message from one of the one or more reference responder devices based on a second RAT, where the measurement report message may indicate an inter-responder clock offset between the target responder device and the one of the one or more reference responder devices. In some aspects, the initiator device may determine the target relative clock offset further based on determining a reference clock offset associated with the one of the one or more reference responder devices, determining an estimated clock offset associated with the target responder device based on the inter-responder clock offset and the reference clock offset, and determining the target relative clock offset based on the estimated clock offset and an initiator clock offset associated with the initiator device. In some aspects, the target relative clock offset may be determined based on the examples illustrated with reference to FIGS. 8 and 9.

In some aspects, the inter-responder clock offset may be determined based on a ranging response message from the target responder device, and may be determined by the one of the one or more reference responder devices or a processing device coupled to the one of the one or more reference responder devices. In some aspects, the initiator device may determine the target relative clock offset based on receiving an indication from the one of the one or more reference responder devices based on the second RAT prior to the ranging initiation message being transmitted, and the indication may indicate that the one of the one or more reference responder devices is capable of providing the inter-responder clock offset.

In some aspects, the initiator device may determine the target relative clock offset based on determining a set of relative clock offsets between the initiator device and the second subset of the plurality of responder devices, determining an average clock offset of the set of relative clock offsets, and determining the target relative clock offset based on the average clock offset. In some aspects, the initiator device may determine the target relative clock offset further based on receiving a plurality of indications from the plurality of responder devices based on a second RAT prior to the ranging initiation message being transmitted, where the plurality of indications may indicate that none of the plurality of responder devices are capable of providing an inter-responder clock offset between the target responder device and any one of the one or more reference responder devices.

In some aspects, the first RAT corresponds to an ultra-wideband radio access technology based on a first channel bandwidth. In some aspects, the second RAT corresponds to a short-range radio access technology based on a second channel bandwidth that is one-third or less of the first channel bandwidth.

At operation 1040, the initiator device may determine a time of flight between the initiator device and the target responder device based on one or more time of flight measurements and the target relative clock offset. In some aspects, the one or more time of flight measurements may include (i) a first reception time of the ranging initiation message received by the target responder device, or a second reception time of the ranging final message received by the target responder device; and (ii) a third reception time of the corresponding ranging response messages from the target responder device received by the initiator device. In some aspects, operation 1040 may be performed by the one or more WWAN transceivers 310, the one or more short-range wireless transceivers 320, the one or more processors 342, the memory 340, and/or the ultra-wideband component 348, any or all of which may be considered means for performing operation 1040.

In some aspects, operation 1030 may be performed in response to the presence of one or more responder devices qualifying as the first subset of the plurality of responder devices (e.g., having successful reception of either the ranging initiation message or the ranging final message) as a result of, e.g., interference. In some aspects, when operation 1030 is omitted due to the reception of the ranging initiation message and the ranging final message is not affected by the interference (i.e., absence of the first subset of the plurality of responder devices), operation 1040 may be performed based on the one or more time of flight measurements without considering the target relative clock offset.

As will be appreciated, a technical advantage of the method 1000 is determining a target relative clock offset of a target responder device that is not DS-TWR capable based on additional information from one or more reference responder devices that are DS-TWR capable in order to allow a positioning procedure based on the target responder device still be performed with improved accuracy. Accordingly, the measurement results associated with the target responder device that is not DS-TWR capable may still be usable for determining a location of the initiator device with sufficient accuracy.

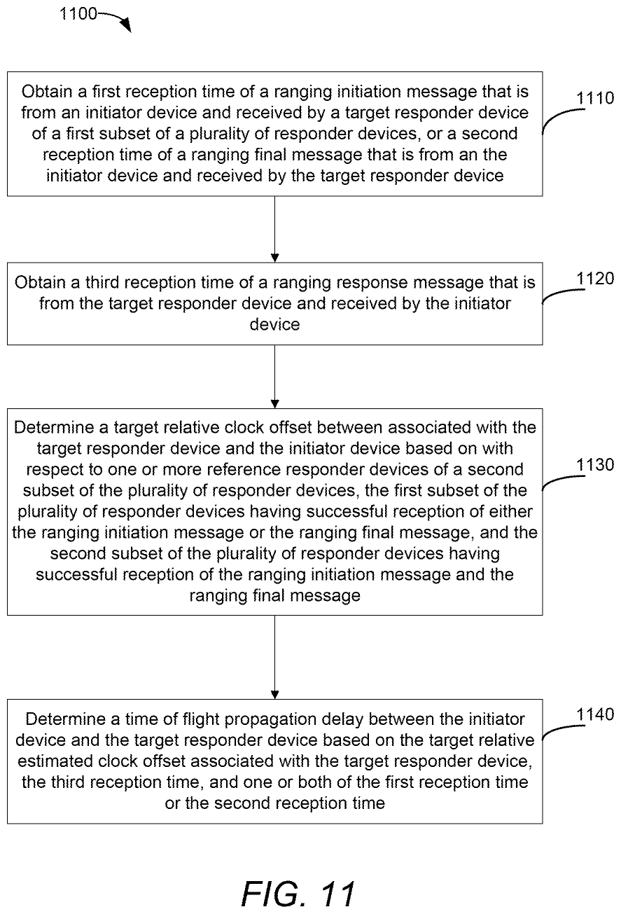

FIG. 11 is a flowchart illustrating a method 1100 of operating a processing device, according to aspects of the disclosure. In some aspects, the processing device in the method 1100 may correspond to a processing device embedded in a responder device or a processing device coupled to a plurality of responder devices as described in FIGS. 8 and 9. In some aspects, the processing device may be embedded in a responder device that may be a wireless communication device 300 described in FIG. 3A; and the method 1100 may be performed by the one or more WWAN transceivers 310, the one or more short-range wireless transceivers 320, the one or more processors 342, the memory 340, and/or the ultra-wideband component 348, any or all of which may be considered means for performing one or more of the following operations of method 1100. In some aspects, the processing device may be a processing device 360 described in FIG. 3B; and the method 1100 may be performed by the one or more network transceivers 390, the one or more processors 394, the memory 396, and/or the ultra-wideband component 398, any or all of which may be considered means for performing one or more of the following operations of method 1100.

At operation 1110, the processing device may obtain a first reception time of a ranging initiation message (e.g., an RIM at slot 822 in FIG. 8 and/or an RIM at stage 930 in FIG. 9) that is from an initiator device and received by a target responder device of a first subset of a plurality of responder devices, or a second reception time of a ranging final message (e.g., an RFM at slot 824 in FIG. 8 and/or an RFM at stage 930 in FIG. 9) that is from the initiator device and received by the target responder device. In some aspects, operation 1110 may be performed by the one or more WWAN transceivers 310, the one or more short-range wireless transceivers 320, the one or more processors 342, the memory 340, and/or the ultra-wideband component 348, any or all of which may be considered means for performing operation 1110. In some aspects, operation 1110 may be performed by the one or more network transceivers 390, the one or more processors 394, the memory 396, and/or the ultra-wideband component 398, any or all of which may be considered means for performing operation 1110.

At operation 1120, the processing device may obtain a third reception time of a ranging response message (e.g., one of the RRMs at slots 831-839 in FIG. 8 and/or a subset of the RRMs at stage 930 in FIG. 9) that is from the target responder device and received by the initiator device. In some aspects, operation 1120 may be performed by the one or more WWAN transceivers 310, the one or more short-range wireless transceivers 320, the one or more processors 342, the memory 340, and/or the ultra-wideband component 348, any or all of which may be considered means for performing operation 1120. In some aspects, operation 1120 may be performed by the one or more network transceivers 390, the one or more processors 394, the memory 396, and/or the ultra-wideband component 398, any or all of which may be considered means for performing operation 1120.

At operation 1130, the processing device may determine a target relative clock offset between the target responder device and the initiator device based on one or more reference responder devices of a second subset of the plurality of responder devices. In some aspects, the first subset of the plurality of responder devices may have successful reception of either the ranging initiation message or the ranging final message. In some aspects, operation 1130 may be performed by the one or more WWAN transceivers 310, the one or more short-range wireless transceivers 320, the one or more processors 342, the memory 340, and/or the ultra-wideband component 348, any or all of which may be considered means for performing operation 1130. In some aspects, operation 1130 may be performed by the one or more network transceivers 390, the one or more processors 394, the memory 396, and/or the ultra-wideband component 398, any or all of which may be considered means for performing operation 1130.

In some aspects, the processing device may determine the target relative clock offset based on receiving a first measurement report message from one of the one or more reference responder devices, and receiving a second measurement report message from the initiator device or the one of the one or more reference responder devices. In some aspects, the first measurement report message may indicate an inter-responder clock offset between the target responder device and the one of the one or more reference responder devices. In some aspects, the second measurement report may indicate a reference clock offset associated with the one of the one or more reference responder devices. In some aspects, the processing device may determine the target relative clock offset further based on determining an estimated clock offset associated with the target responder based on the inter-responder clock offset and the reference clock offset, and may determine the target relative clock offset based on the estimated clock offset and an initiator clock offset associated with the initiator device.

In some aspects, the inter-responder clock offset may be determined based on a ranging response message from the target responder device, and may be determined by the one of the one or more reference responder devices or the processing device. In some aspects, the processing device may receive an indication from the one of the one or more reference responder devices, and the indication may indicate that the one of the one or more reference responder devices is capable of providing the inter-responder clock offset.

In some aspects, the processing device may determine, on a periodic basis or an on-demand basis, inter-responder clock offsets among various pairs of the plurality of responder devices based on ranging response messages from the plurality of responder devices.

In some aspects, the processing device may determine the target relative clock offset based on receiving a third measurement report message from the initiator device, where the third measurement report may indicate a set of relative clock offsets between the initiator device and the second subset of the plurality of responder devices. In some aspects, the processing device may determine the target relative clock offset further based on determining an average clock offset of the set of relative clock offsets, and determining the target relative clock offset based on the average clock offset. In some aspects, the processing device may receive a plurality of indications from the plurality of responder devices. In some aspects, the plurality of indications may indicate that none of the plurality of responder devices are capable of providing an inter-responder clock offset between the target responder device and any one of the one or more reference responder devices.

At operation 1140, the initiator device may determine a time of flight between the initiator device and the target responder device based on the target relative clock offset associated with the target responder device, the third reception time, and one of the first reception time or the second reception time. In some aspects, the time of flight between the initiator device and the target responder device may be determined further based on (i) a first reception time of the ranging initiation message received by the target responder device, or a second reception time of the ranging final message received by the target responder device; and (ii) a third reception time of the corresponding ranging response messages from the target responder device received by the initiator device.

In some aspects, operation 1140 may be performed by the one or more WWAN transceivers 310, the one or more short-range wireless transceivers 320, the one or more processors 342, the memory 340, and/or the ultra-wideband component 348, any or all of which may be considered means for performing operation 1140. In some aspects, operation 1140 may be performed by the one or more network transceivers 390, the one or more processors 394, the memory 396, and/or the ultra-wideband component 398, any or all of which may be considered means for performing operation 1140.

As will be appreciated, a technical advantage of the method 1100 is determining a target relative clock offset of a target responder device that is not DS-TWR capable based on additional information from one or more reference responder devices that are DS-TWR capable in order to allow a positioning procedure based on the target responder device still be performed with improved accuracy. Accordingly, the measurement results associated with the target responder device that is not DS-TWR capable may still be usable for determining a location of the initiator device with sufficient accuracy.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating an initiator device, the method comprising: transmitting a ranging initiation message to a plurality of responder devices based on a first radio access technology (RAT); transmitting a ranging final message to the plurality of responder devices based on the first RAT; determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determining a time of flight between the initiator device and the target responder device based on one or more time of flight measurements and the target relative clock offset.

Clause 2. The method of clause 1, further comprising: receiving a plurality of ranging response messages from the plurality of responder devices based on the first RAT.

Clause 3. The method of clause 2, wherein the one or more time of flight measurements comprise: a first reception time of the ranging initiation message received by the target responder device, or a second reception time of the ranging final message received by the target responder device; and a third reception time of the corresponding ranging response messages from the target responder device received by the initiator device.

Clause 4. The method of any of clauses 1 to 3, wherein the determining the target relative clock offset comprises: receiving a measurement report message from one of the one or more reference responder devices based on a second RAT, the measurement report message indicating an inter-responder clock offset between the target responder device and the one of the one or more reference responder devices; determining a reference clock offset associated with the one of the one or more reference responder devices; determining an estimated clock offset associated with the target responder device based on the inter-responder clock offset and the reference clock offset; and determining the target relative clock offset based on the estimated clock offset and an initiator clock offset associated with the initiator device.

Clause 5. The method of clause 4, wherein the inter-responder clock offset is determined based on a ranging response message from the target responder device, and is determined by the one of the one or more reference responder devices or a processing device coupled to the one of the one or more reference responder devices.

Clause 6. The method of any of clauses 4 to 5, further comprising: receiving an indication from the one of the one or more reference responder devices based on the second RAT prior to the ranging initiation message being transmitted, the indication indicating that the one of the one or more reference responder devices is capable of providing the inter-responder clock offset.

Clause 7. The method of any of clauses 4 to 6, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 8. The method of any of clauses 1 to 3, wherein the determining the target relative clock offset comprises: determining a set of relative clock offsets between the initiator device and the second subset of the plurality of responder devices; determining an average clock offset of the set of relative clock offsets; and determining the target relative clock offset based on the average clock offset.

Clause 9. The method of clause 8, further comprising: receiving a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

Clause 10. The method of clause 9, wherein: the first RAT corresponds to an ultra-wideband communication standard based on a first channel bandwidth, and the second RAT corresponds to a short-range communication standard based on a second channel bandwidth that is one-third or less of the first channel bandwidth.

Clause 11. A method of operating a processing device, the method comprising: obtaining a first reception time of a ranging initiation message that is from an initiator device and received by a target responder device of a first subset of a plurality of responder devices, or a second reception time of a ranging final message that is from the initiator device and received by the target responder device; obtaining a third reception time of a ranging response message that is from the target responder device and received by the initiator device; determining a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determining a time of flight between the initiator device and the target responder device based on the target relative clock offset associated with the target responder device, the third reception time, and one or both of the first reception time or the second reception time.

Clause 12. The method of clause 11, wherein the determining the target relative clock offset comprises: Receiving a first measurement report message from one of the one or more reference responder devices, the first measurement report message indicating an inter-responder clock offset between the target responder device and the one of the one or more reference responder devices; receiving a second measurement report message from the initiator device or the one of the one or more reference responder devices, the second measurement report indicating a reference clock offset associated with the one of the one or more reference responder devices; determining an estimated clock offset associated with the target responder based on the inter-responder clock offset and the reference clock offset; and determining the target relative clock offset based on the estimated clock offset and an initiator clock offset associated with the initiator device.

Clause 13. The method of clause 12, wherein the inter-responder clock offset is determined based on a ranging response message from the target responder device, and is determined by the one of the one or more reference responder devices or the processing device.

Clause 14. The method of any of clauses 12 to 13, further comprising: receiving an indication from the one of the one or more reference responder devices, the indication indicating that the one of the one or more reference responder devices is capable of providing the inter-responder clock offset.

Clause 15. The method of any of clauses 11 to 14, further comprising: determining, on a periodic basis or an on-demand basis, inter-responder clock offsets among various pairs of the plurality of responder devices based on ranging response messages from the plurality of responder devices.

Clause 16. The method of clause 11, wherein the determining the target relative clock offset comprises: receiving a third measurement report message from the initiator device, the third measurement report indicating a set of relative clock offsets between the initiator device and the second subset of the plurality of responder devices; determining an average clock offset of the set of relative clock offsets; and determining the target relative clock offset based on the average clock offset.

Clause 17. The method of clause 16, further comprising: receiving a plurality of indications from the plurality of responder devices, the plurality of indications indicating that none of the plurality of responder devices are capable of providing an inter-responder clock offset between the target responder device and any one of the one or more reference responder devices.

Clause 18. The method of any of clauses 11 to 17, wherein: the processing device is one of the plurality of responder devices; or the processing device is communicatively coupled with the plurality of responder devices.

Clause 19. An initiator device, comprising: one or more memories; one or more transceivers; and one or more processors communicatively coupled to the one or more memories and the one or more transceivers, the one or more processors, either alone or in combination, configured to: transmit, via the one or more transceivers, a ranging initiation message to a plurality of responder devices based on a first radio access technology (RAT); transmit, via the one or more transceivers, a ranging final message to the plurality of responder devices based on the first RAT; determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on one or more time of flight measurements and the target relative clock offset.

Clause 20. The initiator device of clause 19, wherein the one or more processors, either alone or in combination, are further configured to: receive, via the one or more transceivers, a plurality of ranging response messages from the plurality of responder devices based on the first RAT.

Clause 21. The initiator device of clause 20, wherein the one or more time of flight measurements comprise: a first reception time of the ranging initiation message received by the target responder device, or a second reception time of the ranging final message received by the target responder device; and a third reception time of the corresponding ranging response messages from the target responder device received by the initiator device.

Clause 22. The initiator device of any of clauses 19 to 21, wherein the one or more processors, either alone or in combination, configured to determine the target relative clock offset are further configured to: receive, via the one or more transceivers, a measurement report message from one of the one or more reference responder devices based on a second RAT, the measurement report message indicating an inter-responder clock offset between the target responder device and the one of the one or more reference responder devices; determine a reference clock offset associated with the one of the one or more reference responder devices; determine an estimated clock offset associated with the target responder device based on the inter-responder clock offset and the reference clock offset; and determine the target relative clock offset based on the estimated clock offset and an initiator clock offset associated with the initiator device.

Clause 23. The initiator device of clause 22, wherein the inter-responder clock offset is determined based on a ranging response message from the target responder device, and is determined by the one of the one or more reference responder devices or a processing device coupled to the one of the one or more reference responder devices.

Clause 24. The initiator device of any of clauses 22 to 23, wherein the one or more processors, either alone or in combination, are further configured to: receive, via the one or more transceivers, an indication from the one of the one or more reference responder devices based on the second RAT prior to the ranging initiation message being transmitted, the indication indicating that the one of the one or more reference responder devices is capable of providing the inter-responder clock offset.

Clause 25. The initiator device of any of clauses 22 to 24, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 26. The initiator device of any of clauses 19 to 21, wherein the one or more processors, either alone or in combination, configured to determine the target relative clock offset are further configured to: determine a set of relative clock offsets between the initiator device and the second subset of the plurality of responder devices; determine an average clock offset of the set of relative clock offsets; and determine the target relative clock offset based on the average clock offset.

Clause 27. The initiator device of clause 26, wherein the one or more processors, either alone or in combination, are further configured to: receive, via the one or more transceivers, a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

Clause 28. The initiator device of clause 27, wherein: the first RAT corresponds to an ultra-wideband communication standard based on a first channel bandwidth, and the second RAT corresponds to a short-range communication standard based on a second channel bandwidth that is one-third or less of the first channel bandwidth.

Clause 29. A processing device, comprising: one or more memories; one or more transceivers; and one or more processors communicatively coupled to the one or more memories and the one or more transceivers, the one or more processors, either alone or in combination, configured to: obtain a first reception time of a ranging initiation message that is from an initiator device and received by a target responder device of a first subset of a plurality of responder devices, or a second reception time of a ranging final message that is from the initiator device and received by the target responder device; obtain a third reception time of a ranging response message that is from the target responder device and received by the initiator device; determine a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on the target relative clock offset associated with the target responder device, the third reception time, and one or both of the first reception time or the second reception time.

Clause 30. The processing device of clause 29, wherein the one or more processors, either alone or in combination, configured to determine the target relative clock offset are further configured to: receive a first measurement report message from one of the one or more reference responder devices, the first measurement report message indicating an inter-responder clock offset between the target responder device and the one of the one or more reference responder devices; receive, via the one or more transceivers, a second measurement report message from the initiator device or the one of the one or more reference responder devices, the second measurement report indicating a reference clock offset associated with the one of the one or more reference responder devices; determine an estimated clock offset associated with the target responder based on the inter-responder clock offset and the reference clock offset; and determine the target relative clock offset based on the estimated clock offset and an initiator clock offset associated with the initiator device.

Clause 31. The processing device of clause 30, wherein the inter-responder clock offset is determined based on a ranging response message from the target responder device, and is determined by the one of the one or more reference responder devices or the processing device.

Clause 32. The processing device of any of clauses 30 to 31, wherein the one or more processors, either alone or in combination, are further configured to: receive, via the one or more transceivers, an indication from the one of the one or more reference responder devices, the indication indicating that the one of the one or more reference responder devices is capable of providing the inter-responder clock offset.

Clause 33. The processing device of any of clauses 29 to 32, wherein the one or more processors, either alone or in combination, are further configured to: determine, on a periodic basis or an on-demand basis, inter-responder clock offsets among various pairs of the plurality of responder devices based on ranging response messages from the plurality of responder devices.

Clause 34. The processing device of clause 29, wherein the one or more processors, either alone or in combination, configured to determine the target relative clock offset are further configured to: receive, via the one or more transceivers, a third measurement report message from the initiator device, the third measurement report indicating a set of relative clock offsets between the initiator device and the second subset of the plurality of responder devices; determine an average clock offset of the set of relative clock offsets; and determine the target relative clock offset based on the average clock offset.

Clause 35. The processing device of clause 34, wherein the one or more processors, either alone or in combination, are further configured to: receive, via the one or more transceivers, a plurality of indications from the plurality of responder devices, the plurality of indications indicating that none of the plurality of responder devices are capable of providing an inter-responder clock offset between the target responder device and any one of the one or more reference responder devices.

Clause 36. The processing device of any of clauses 29 to 35, wherein: the processing device is one of the plurality of responder devices; or the processing device is communicatively coupled with the plurality of responder devices.

Clause 37. An initiator device, comprising: means for transmitting a ranging initiation message to a plurality of responder devices based on a first radio access technology (RAT); means for transmitting a ranging final message to the plurality of responder devices based on the first RAT; means for determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and means for determining a time of flight between the initiator device and the target responder device based on one or more time of flight measurements and the target relative clock offset.

Clause 38. The initiator device of clause 37, further comprising: means for receiving a plurality of ranging response messages from the plurality of responder devices based on the first RAT.

Clause 39. The initiator device of clause 38, wherein the one or more time of flight measurements comprise: a first reception time of the ranging initiation message received by the target responder device, or a second reception time of the ranging final message received by the target responder device; and a third reception time of the corresponding ranging response messages from the target responder device received by the initiator device.

Clause 40. The initiator device of any of clauses 37 to 39, wherein the means for determining the target relative clock offset comprises: means for receiving a measurement report message from one of the one or more reference responder devices based on a second RAT, the measurement report message indicating an inter-responder clock offset between the target responder device and the one of the one or more reference responder devices; means for determining a reference clock offset associated with the one of the one or more reference responder devices; means for determining an estimated clock offset associated with the target responder device based on the inter-responder clock offset and the reference clock offset; and means for determining the target relative clock offset based on the estimated clock offset and an initiator clock offset associated with the initiator device.

Clause 41. The initiator device of clause 40, wherein the inter-responder clock offset is determined based on a ranging response message from the target responder device, and is determined by the one of the one or more reference responder devices or a processing device coupled to the one of the one or more reference responder devices.

Clause 42. The initiator device of any of clauses 40 to 41, further comprising: means for receiving an indication from the one of the one or more reference responder devices based on the second RAT prior to the ranging initiation message being transmitted, the indication indicating that the one of the one or more reference responder devices is capable of providing the inter-responder clock offset.

Clause 43. The initiator device of any of clauses 40 to 42, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 44. The initiator device of any of clauses 37 to 39, wherein the means for determining the target relative clock offset comprises: means for determining a set of relative clock offsets between the initiator device and the second subset of the plurality of responder devices; means for determining an average clock offset of the set of relative clock offsets; and means for determining the target relative clock offset based on the average clock offset.

Clause 45. The initiator device of clause 44, further comprising: means for receiving a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

Clause 46. The initiator device of clause 45, wherein: the first RAT corresponds to an ultra-wideband communication standard based on a first channel bandwidth, and the second RAT corresponds to a short-range communication standard based on a second channel bandwidth that is one-third or less of the first channel bandwidth.

Clause 47. A processing device, comprising: means for obtaining a first reception time of a ranging initiation message that is from an initiator device and received by a target responder device of a first subset of a plurality of responder devices, or a second reception time of a ranging final message that is from the initiator device and received by the target responder device; means for obtaining a third reception time of a ranging response message that is from the target responder device and received by the initiator device; means for determining a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and means for determining a time of flight between the initiator device and the target responder device based on the target relative clock offset associated with the target responder device, the third reception time, and one or both of the first reception time or the second reception time.

Clause 48. The processing device of clause 47, wherein the means for determining the target relative clock offset comprises: means for Receiving a first measurement report message from one of the one or more reference responder devices, the first measurement report message indicating an inter-responder clock offset between the target responder device and the one of the one or more reference responder devices; means for receiving a second measurement report message from the initiator device or the one of the one or more reference responder devices, the second measurement report indicating a reference clock offset associated with the one of the one or more reference responder devices; means for determining an estimated clock offset associated with the target responder based on the inter-responder clock offset and the reference clock offset; and means for determining the target relative clock offset based on the estimated clock offset and an initiator clock offset associated with the initiator device.

Clause 49. The processing device of clause 48, wherein the inter-responder clock offset is determined based on a ranging response message from the target responder device, and is determined by the one of the one or more reference responder devices or the processing device.

Clause 50. The processing device of any of clauses 48 to 49, further comprising: means for receiving an indication from the one of the one or more reference responder devices, the indication indicating that the one of the one or more reference responder devices is capable of providing the inter-responder clock offset.

Clause 51. The processing device of any of clauses 47 to 50, further comprising: means for determining, on a periodic basis or an on-demand basis, inter-responder clock offsets among various pairs of the plurality of responder devices based on ranging response messages from the plurality of responder devices.

Clause 52. The processing device of clause 47, wherein the means for determining the target relative clock offset comprises: means for receiving a third measurement report message from the initiator device, the third measurement report indicating a set of relative clock offsets between the initiator device and the second subset of the plurality of responder devices; means for determining an average clock offset of the set of relative clock offsets; and means for determining the target relative clock offset based on the average clock offset.

Clause 53. The processing device of clause 52, further comprising: means for receiving a plurality of indications from the plurality of responder devices, the plurality of indications indicating that none of the plurality of responder devices are capable of providing an inter-responder clock offset between the target responder device and any one of the one or more reference responder devices.

Clause 54. The processing device of any of clauses 47 to 53, wherein: the processing device is one of the plurality of responder devices; or the processing device is communicatively coupled with the plurality of responder devices.

Clause 55. A non-transitory computer-readable medium storing computer-executable instructions that, when executed by an initiator device, cause the initiator device to: transmit a ranging initiation message to a plurality of responder devices based on a first radio access technology (RAT); transmit a ranging final message to the plurality of responder devices based on the first RAT; determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on one or more time of flight measurements and the target relative clock offset.

Clause 56. The non-transitory computer-readable medium of clause 55, further comprising computer-executable instructions that, when executed by the initiator device, cause the initiator device to: receive a plurality of ranging response messages from the plurality of responder devices based on the first RAT.

Clause 57. The non-transitory computer-readable medium of clause 56, wherein the one or more time of flight measurements comprise: a first reception time of the ranging initiation message received by the target responder device, or a second reception time of the ranging final message received by the target responder device; and a third reception time of the corresponding ranging response messages from the target responder device received by the initiator device.

Clause 58. The non-transitory computer-readable medium of any of clauses 55 to 57, wherein the computer-executable instructions that, when executed by the initiator device, cause the initiator device to determine the target relative clock offset comprise computer-executable instructions that, when executed by the initiator device, cause the initiator device to: receive a measurement report message from one of the one or more reference responder devices based on a second RAT, the measurement report message indicating an inter-responder clock offset between the target responder device and the one of the one or more reference responder devices; determine a reference clock offset associated with the one of the one or more reference responder devices; determine an estimated clock offset associated with the target responder device based on the inter-responder clock offset and the reference clock offset; and determine the target relative clock offset based on the estimated clock offset and an initiator clock offset associated with the initiator device.

Clause 59. The non-transitory computer-readable medium of clause 58, wherein the inter-responder clock offset is determined based on a ranging response message from the target responder device, and is determined by the one of the one or more reference responder devices or a processing device coupled to the one of the one or more reference responder devices.

Clause 60. The non-transitory computer-readable medium of any of clauses 58 to 59, further comprising computer-executable instructions that, when executed by the initiator device, cause the initiator device to: receive an indication from the one of the one or more reference responder devices based on the second RAT prior to the ranging initiation message being transmitted, the indication indicating that the one of the one or more reference responder devices is capable of providing the inter-responder clock offset.

Clause 61. The non-transitory computer-readable medium of any of clauses 58 to 60, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 62. The non-transitory computer-readable medium of any of clauses 55 to 57, wherein the computer-executable instructions that, when executed by the initiator device, cause the initiator device to determine the target relative clock offset comprise computer-executable instructions that, when executed by the initiator device, cause the initiator device to: determine a set of relative clock offsets between the initiator device and the second subset of the plurality of responder devices; determine an average clock offset of the set of relative clock offsets; and determine the target relative clock offset based on the average clock offset.

Clause 63. The non-transitory computer-readable medium of clause 62, further comprising computer-executable instructions that, when executed by the initiator device, cause the initiator device to: receive a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

Clause 64. The non-transitory computer-readable medium of clause 63, wherein: the first RAT corresponds to an ultra-wideband communication standard based on a first channel bandwidth, and the second RAT corresponds to a short-range communication standard based on a second channel bandwidth that is one-third or less of the first channel bandwidth.

Clause 65. A non-transitory computer-readable medium storing computer-executable instructions that, when executed by a processing device, cause the processing device to: obtain a first reception time of a ranging initiation message that is from an initiator device and received by a target responder device of a first subset of a plurality of responder devices, or a second reception time of a ranging final message that is from the initiator device and received by the target responder device; obtain a third reception time of a ranging response message that is from the target responder device and received by the initiator device; determine a target relative clock offset between the target responder device and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and determine a time of flight between the initiator device and the target responder device based on the target relative clock offset associated with the target responder device, the third reception time, and one or both of the first reception time or the second reception time.

Clause 66. The non-transitory computer-readable medium of clause 65, wherein the computer-executable instructions that, when executed by the initiator device, cause the initiator device to determine the target relative clock offset comprise computer-executable instructions that, when executed by the initiator device, cause the initiator device to: receive a first measurement report message from one of the one or more reference responder devices, the first measurement report message indicating an inter-responder clock offset between the target responder device and the one of the one or more reference responder devices; receive a second measurement report message from the initiator device or the one of the one or more reference responder devices, the second measurement report indicating a reference clock offset associated with the one of the one or more reference responder devices; determine an estimated clock offset associated with the target responder based on the inter-responder clock offset and the reference clock offset; and determine the target relative clock offset based on the estimated clock offset and an initiator clock offset associated with the initiator device.

Clause 67. The non-transitory computer-readable medium of clause 66, wherein the inter-responder clock offset is determined based on a ranging response message from the target responder device, and is determined by the one of the one or more reference responder devices or the processing device.

Clause 68. The non-transitory computer-readable medium of any of clauses 66 to 67, further comprising computer-executable instructions that, when executed by the processing device, cause the processing device to: receive an indication from the one of the one or more reference responder devices, the indication indicating that the one of the one or more reference responder devices is capable of providing the inter-responder clock offset.

Clause 69. The non-transitory computer-readable medium of any of clauses 65 to 68, further comprising computer-executable instructions that, when executed by the processing device, cause the processing device to: determine, on a periodic basis or an on-demand basis, inter-responder clock offsets among various pairs of the plurality of responder devices based on ranging response messages from the plurality of responder devices.

Clause 70. The non-transitory computer-readable medium of clause 65, wherein the computer-executable instructions that, when executed by the initiator device, cause the initiator device to determine the target relative clock offset comprise computer-executable instructions that, when executed by the initiator device, cause the initiator device to: receive a third measurement report message from the initiator device, the third measurement report indicating a set of relative clock offsets between the initiator device and the second subset of the plurality of responder devices; determine an average clock offset of the set of relative clock offsets; and determine the target relative clock offset based on the average clock offset.

Clause 71. The non-transitory computer-readable medium of clause 70, further comprising computer-executable instructions that, when executed by the processing device, cause the processing device to: receive a plurality of indications from the plurality of responder devices, the plurality of indications indicating that none of the plurality of responder devices are capable of providing an inter-responder clock offset between the target responder device and any one of the one or more reference responder devices.

Clause 72. The non-transitory computer-readable medium of any of clauses 65 to 71, wherein: the processing device is one of the plurality of responder devices; or the processing device is communicatively coupled with the plurality of responder devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of operating an initiator device, the method comprising:
transmitting a ranging initiation message to a plurality of responder devices based on a first radio access technology (RAT);
transmitting a ranging final message to the plurality of responder devices based on the first RAT;
determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and
determining a time of flight between the initiator device and the target responder device based on one or more time of flight measurements and the target relative clock offset.

2. The method of claim 1, further comprising:
receiving a plurality of ranging response messages from the plurality of responder devices based on the first RAT.

3. The method of claim 2, wherein the one or more time of flight measurements comprise:
a first reception time of the ranging initiation message received by the target responder device, or a second reception time of the ranging final message received by the target responder device; and
a third reception time of the corresponding ranging response messages from the target responder device received by the initiator device.

4. The method of claim 1, wherein the determining the target relative clock offset comprises:
receiving a measurement report message from one of the one or more reference responder devices based on a second RAT, the measurement report message indicating an inter-responder clock offset between the target responder device and the one of the one or more reference responder devices;
determining a reference clock offset associated with the one of the one or more reference responder devices;
determining an estimated clock offset associated with the target responder device based on the inter-responder clock offset and the reference clock offset; and
determining the target relative clock offset based on the estimated clock offset and an initiator clock offset associated with the initiator device.

5. The method of claim 4, further comprising:
receiving an indication from the one of the one or more reference responder devices based on the second RAT prior to the ranging initiation message being transmitted, the indication indicating that the one of the one or more reference responder devices is capable of providing the inter-responder clock offset.

6. The method of claim 4, wherein:
the first RAT corresponds to an ultra-wideband radio access technology based on a first channel bandwidth, and
the second RAT corresponds to a short-range radio access technology based on a second channel bandwidth that is one-third or less of the first channel bandwidth.

7. The method of claim 1, wherein the determining the target relative clock offset comprises:
determining a set of relative clock offsets between the initiator device and the second subset of the plurality of responder devices;
determining an average clock offset of the set of relative clock offsets; and
determining the target relative clock offset based on the average clock offset.

8. The method of claim 7, further comprising:
receiving a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

9. The method of claim 8, wherein:
the first RAT corresponds to an ultra-wideband communication standard based on a first channel bandwidth, and
the second RAT corresponds to a short-range communication standard based on a second channel bandwidth that is one-third or less of the first channel bandwidth.

10. An initiator device, comprising:
one or more memories;
one or more transceivers; and
one or more processors communicatively coupled to the one or more memories and the one or more transceivers, the one or more processors, either alone or in combination, configured to:
transmit, via the one or more transceivers, a ranging initiation message to a plurality of responder devices based on a first radio access technology (RAT);
transmit, via the one or more transceivers, a ranging final message to the plurality of responder devices based on the first RAT;
determine a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and
determine a time of flight between the initiator device and the target responder device based on one or more time of flight measurements and the target relative clock offset.

11. The initiator device of claim 10, wherein the one or more processors, either alone or in combination, are further configured to:
receive, via the one or more transceivers, a plurality of ranging response messages from the plurality of responder devices based on the first RAT.

12. The initiator device of claim 11, wherein the one or more time of flight measurements comprise:
a first reception time of the ranging initiation message received by the target responder device, or a second reception time of the ranging final message received by the target responder device; and
a third reception time of the corresponding ranging response messages from the target responder device received by the initiator device.

13. The initiator device of claim 10, wherein the one or more processors, either alone or in combination, configured to determine the target relative clock offset are further configured to:
receive, via the one or more transceivers, a measurement report message from one of the one or more reference responder devices based on a second RAT, the measurement report message indicating an inter-responder clock offset between the target responder device and the one of the one or more reference responder devices;
determine a reference clock offset associated with the one of the one or more reference responder devices;
determine an estimated clock offset associated with the target responder device based on the inter-responder clock offset and the reference clock offset; and
determine the target relative clock offset based on the estimated clock offset and an initiator clock offset associated with the initiator device.

14. The initiator device of claim 13, wherein the inter-responder clock offset is determined based on a ranging response message from the target responder device, and is determined by the one of the one or more reference responder devices or a processing device coupled to the one of the one or more reference responder devices.

15. The initiator device of claim 13, wherein the one or more processors, either alone or in combination, are further configured to:
receive, via the one or more transceivers, an indication from the one of the one or more reference responder devices based on the second RAT prior to the ranging initiation message being transmitted, the indication indicating that the one of the one or more reference responder devices is capable of providing the inter-responder clock offset.

16. The initiator device of claim 13, wherein:
the first RAT corresponds to an ultra-wideband radio access technology based on a first channel bandwidth, and
the second RAT corresponds to a short-range radio access technology based on a second channel bandwidth that is one-third or less of the first channel bandwidth.

17. The initiator device of claim 10, wherein the one or more processors, either alone or in combination, configured to determine the target relative clock offset are further configured to:
determine a set of relative clock offsets between the initiator device and the second subset of the plurality of responder devices;
determine an average clock offset of the set of relative clock offsets; and
determine the target relative clock offset based on the average clock offset.

18. The initiator device of claim 17, wherein the one or more processors, either alone or in combination, are further configured to:
receive, via the one or more transceivers, a plurality of indications from the plurality of responder devices based on a second RAT prior to the ranging initiation message being transmitted, the plurality of indications indicating that none of the plurality of responder devices are capable of providing an inter-responder clock offset between the target responder device and any one of the one or more reference responder devices.

19. The initiator device of claim 18, wherein:
the first RAT corresponds to an ultra-wideband communication standard based on a first channel bandwidth, and
the second RAT corresponds to a short-range communication standard based on a second channel bandwidth that is one-third or less of the first channel bandwidth.

20. An initiator device, comprising:
means for transmitting a ranging initiation message to a plurality of responder devices based on a first radio access technology (RAT);
means for transmitting a ranging final message to the plurality of responder devices based on the first RAT;
means for determining a target relative clock offset between a target responder device of a first subset of the plurality of responder devices and the initiator device based on one or more reference responder devices of a second subset of the plurality of responder devices, the first subset of the plurality of responder devices having successful reception of either the ranging initiation message or the ranging final message, and the second subset of the plurality of responder devices having successful reception of the ranging initiation message and the ranging final message; and
means for determining a time of flight between the initiator device and the target responder device based on one or more time of flight measurements and the target relative clock offset.
